(19) United States
(12) Patent Application Publication
(10) Pub. No.: US 2022/0382521 A1
(43) Pub. Date: Dec. 1, 2022

(54) SYSTEM AND METHOD FOR ENCRYPTION AND DECRYPTION USING LOGIC SYNTHESIS

(71) Applicant: OUSIA Ltd, Athenaz (Avusy) (CH)

(72) Inventors: Petar KRCMARICIC-BARACKOV, Belgrad (RS); Antonio D’AUGENTI, Chiasso TI (CH); Massimo BAZZICHI, Athenaz (Avusy) (CH)

(21) Appl. No.: 17/773,505

(22) PCT Filed: Oct. 30, 2020
(86) PCT No.: PCT/IB2020/060234

§ 371 Date: Apr. 29, 2022

(30) Foreign Application Priority Data
Oct. 31, 2019 (EP) 19206620.7

(51) Int. Cl. G06F 7/78; G06F 7/575

(52) U.S. Cl. CPC G06F 7/78; G06F 7/575

(57) ABSTRACT

Method decrypting and/or encrypting an input message: providing at least five of sixteen first order logic functions; and decrypting and/or encrypting the input message based on the at least five first order logic functions.

### REFERENCE DATA

The present application is a national phase of international patent application PCT/IB2020/060234 of Oct. 30, 2020, which claims priority of European patent application EP19206620.7 of Oct. 31, 2019.

### FIELD OF THE INVENTION

The present invention relates generally to encryption and decryption, and more particularly to improving the security level of existing standard encryption algorithm while optionally adding features usually found in so called Functional Encryption algorithms. The invention proposes a novel cipher technique using logic to generate a cipher algorithm dependent on the encryption key.

### DESCRIPTION OF THE PRIOR ART

Encryption and Decryption

Encryption as traditionally implemented is generally a method of protecting the confidentiality of data. As such, encryption is also used to protect data “at-rest”, as recorded on digital media, and to protect access to data, and as encrypted digital access protocol messages, and to confidentially exchanging messages “in-movement” or “over-the-wire” between at least two parties.

Other goals and uses for encryption other than ensuring privacy or confidentiality of communications include, but are not limited to, data integrity insurance, entity authentication or identification, message authentication, data origin authentication, digital signatures, authorization conveyance, authorization validation, access control, certification or endorsement of information by trusted entities, verifiable timestamping of events and information, witnessing and verifying the creation or existence of information by an entity other than the creator, receipts of reception, acknowledgements and confirmations of service execution, ownership and other ways of providing entities with social and legal rights of use or transfer to others, anonymity and partial identity concealment through some processes, non-repudiation and prevention of denial of previous commitments or actions, revocations of certifications or authorisations. The “Handbook of Applied Cryptography” by A. Menezes, P. van Oorschot and S. Vanstone, 1997, CRC Press is a source of background information on these applications.

Encryption devices, systems and methods transform a data or message, called the “plaintext”, arranged as a sequence of letters, numbers and symbols, into another such sequence which is unintelligible, the “ciphertext”. If the plaintext has to be separated into segments to execute the encryption algorithm, each such segments is called a “block”. If the plaintext is treated symbol by symbol, the plaintext is alternatively called a “stream”. The transformation consists of a device, system or method executing a sequence of instructions over each block, repeated one or more times over each block. The instruction sequence for the system, device or method and how it is applied to transform the data, including a specified number of repetitions called “rounds”, is called the “encryption algorithm”. To make the message intelligible again, the same or another device or method must be executing the inverse or opposite transformations and algorithms with the same key or another key on the transformed, called the “decryption algorithm”, on the ciphertext. In addition to the data or message itself, the sequence of instructions or functions in the algorithm generally uses at least one or more mathematically linked strings of number of letters, kept secret, called the “keyword”, “cipher key” or simply “key”, as a mandatory parameter; other numbers or letter sequences, whose use is mandatory or not, may also be used as additional parameters.

The two main types of techniques for transforming plaintexts into ciphertexts are the substitution of the plaintexts letters, numbers and other symbols by other symbols according to a given set of rules, and the transposition of letters, numbers and other symbols within the message according to another set of rules, as a well as a combination of these two types of mechanisms. These rules are, in effect, the encryption algorithm, while the inverse set of substitutions and permutations are the decryption algorithm. Substitution is meant to confuse third parties, transposition to diffuse the confusing information.

A great example of a substitution cipher is the classic two thousand year old “Caesar Cipher”, where a each letter in the message is replaced by a letter for example a given number of letters “down” in the alphabet (FIG. 1), a classic variant of which is the ROT13 cipher, substituting with a letter 13 letters down the Latin alphabet.

Modern ciphers use much more sophisticated constructions including mathematical substitution and transposition rules exemplified above, including combination thereof, so called product ciphers, or substitution-permutation networks.

Cipher constructions are often applied multiple times to blocks of plaintext. Each of these repeated applications sequences of the cipher construction are called loops. A plaintext block can be as short as a single byte (or 8 bits) in the case of some stream ciphers, or as large as several kilobytes, in some other more exotic ciphers. These loops usually take in a block of the plaintext input, combines it mathematically or logically with some of the cipher's parameters to set up a data structure called the “state” of the cipher, in which the loops output their results. This state is then modified by a given set of instructions, which actually embody the instructions which can render a ciphertext very difficult to decrypt without the key. Some ciphers also have one or more inner loops, applied within a higher-level loop, to each block, modifying the “state”. The specification of the encryption or decryption sequence, including loops, and their output format, is the definition of the algorithm. The innermost loop, or function, may be applied a standard number of times—i.e. so called “rounds” of the inner “round function”, in which case the cipher is called a “Feistel” cipher.

The encryption and decryption algorithms, together with the cipher key or keys, as well as any other parameters and the technical specifications for the implementation of all of the aforementioned elements, such as the standard length of a block are together called a “cipher”.

Cipher Types

Symmetric Ciphers

Ciphers which use the same key for both the encryption and decryption algorithms are called “symmetric” ciphers. With such ciphers, if two parties exchange messages or data, both the emitter of the message as well as its recipient must use the exact same cipher and key, and any other parameters to encrypt and decrypt the message. Messages are kept secret in symmetric ciphers as long as both parties keep the at least the secret key secret, this means both parties must exchange keys securely and confidentially before communicating for the message or data to be kept confidential after their transmission. Symmetric ciphers generally are very efficient from the point of view of computational efficiency, i.e. the number of computations necessary to achieve the desired result is relatively low. As such, they are often used for applications where high transmission performances are necessary: data transfer, video transfers, video communications, etc. Examples of symmetric ciphers used commercially and in the industry around the world to date include the standard American Encryption Standard AES (originally called Rijndael), Blowfish, CAST5, the Russian Kuznyechik standard, RC4, the standard Digital Encryption Standard DES, 3DES, Skipjack, Safer+/++ (used in short-range Bluetooth wireless communications), and IDEA. These contemporary commercial symmetric ciphers often use variants of or constructions using substitution-permutation networks (AES, Kuznyechik, for example), or Feistel ciphers (DES, 3DES).

Symmetric Stream Ciphers

Symmetric ciphers operating on segments of plaintext of a given length using a given key used as a parameter for a looping algorithm are of the type called “block ciphers”. Ciphers operating on strings of symbols of arbitrary length, whereas the key generates a pseudo-random deterministic sequence combined with the plaintext are called “stream ciphers”. These ciphers usually apply the cipher construction functions to a part of the plaintext sometimes as small as a single character and then reapply the same construction to the next part. Well-designed stream ciphers are in effect functions with an extremely long period. Such ciphers sometime output a “state” data structure which is re-used for the following loop applications. If the state is combined with previously computed parts of the ciphertext, the cipher is called a “self-synchronizing stream cipher”. A popular construction with extremely good performance characteristics for stream ciphers are so called “linear shift registers”. Examples of symmetric ciphers used commercially and in the industry around the world to date include the A5 series, used in GSM communication protocols, or the Salsa20 family, used in the web HTTPS protocol.

Asymmetric Ciphers

Ciphers which use a different key pair for respectively encryption and decryption are called “asymmetric ciphers” or “public key ciphers”. To use public key ciphers, both parties each have a pair of mathematically linked keys, one called the “public key”, which can be freely shared, and the other the “private key”, which is supposed to be kept secret.

To send a message confidentially, the emitter uses the recipient's public key encrypt, and which only the recipient can decrypt using his private key. It is generally posited that it is mathematically impossible to decrypt the message with the public key. As such, all private keys are kept exclusively secret.

The private and public key are mathematically linked through “trapdoor one-way functions”, which are mathematical constructions easy to compute in one direction, private to public for example, and supposed to be impossible to compute the other direction, public to private—so called “computationally infeasible”. Breaking or solving an asymmetric cipher is thus equivalent to finding an “easy” solution or a short algorithm to the public to private key inverse function problem.

Example of such functions include integer factorization problems, discrete logarithm problem or the subset sum problem. The main advantage of asymmetric ciphers is that, as long as nobody finds a practical solution to invert the trapdoor one-way function, these algorithms remain secure without need for preliminary confidential exchange of secret keys—which is a necessity for symmetric ciphers.

Asymmetric ciphers are however much more complex to put into practice, as their existence gives rise, by nature, to the need for a way to certify identities and the linked public keys. Contemporary asymmetric ciphers in wide commercial or industrial use include the RSA cipher, the standard Digital Signature Algorithm, the Diffie-Hellman and elliptic curve Diffie-Hellman key agreement protocols.

The main disadvantage of asymmetric ciphers is that if a mathematical or operational weakness exists within the trapdoor function, the entire cipher becomes solvable. In addition, as used in various communication and communication security protocols, such ciphers are very vulnerable to so-called “man-in-the-middle” attacks. Such attacks happen when, at the moment of key negotiation, the attacker substitutes itself to both parties relative to each other, which thereafter do not know that their communication and keys are being decrypted and re-encrypted by the attacker both ways, which the attacker can then use to spoof, masquerade, decrypt, and forge transactions without limit. The solution to that problem is to us a so-called public-key infrastructure (PKI)— a set of roles, policies, and procedures needed to create, manage, distribute, use, store & revoke digital certificates and manage public-key encryption. These PKI schemes often require a third-party certificate and/or validation authority, which themselves are subject to their own set of security and cryptanalysis issues.

Key and Parameter Derivation Algorithmically

Cipher designers specify the keys to be as short as possible to be practical for commercial and industrial use. In practice, commercial programs architects cannot realistically require their users to remember long alphanumeric suites—passwords are used instead. Sometimes, such passwords also need to be verified against a stored, encrypted keys or within key agreement protocols. In other cases, more than one parameter is mathematically required to achieve sufficient security. A solution which is often chosen is to compute, from a password or single key, all of the variables required by the cipher, i.e. to “derive” said variables, from a common secret value.

The algorithms to achieve are called “key derivation functions” (KDF), which are used to compute or expand one or more secret keys from a secret value such as a master key, a password, or a passphrase, using a pseudorandom function. The derived values may be longer than the original master key. KDFs can also be used to obtain keys of a required format, for example after completing an asymmetric key exchange to get a symmetric key. Used with a one-use random value, a KDF can also be used to create longer, more random, stronger keys. Current KDF's have very wide industrial and commercial due to their use in both password verification through hashing and as a parameter derivation tool. Such algorithm use includes bcrypt, scrypt, HKDF, PBKDF2, Argon 2. Due to their use as key verification tools in password hashing, they are very often the target of cryptanalysis.

Cipher Modes

A great number of ciphers, mostly symmetric ciphers, have weaknesses against so-called “known-plaintext attack”. The attacker hypothesises a location for a given text and tries to restructure from the ciphertext the rest of the key. A notable use of that technique was in breaking the German Enigma code during World War II. A similar type of attack, more adapted to asymmetric ciphers, is the “chosen-plaintext attack”, wherein the attacker finds an operational way able to get a chose text encrypted and transmitted by either party. As the encryption algorithm is supposed known, the key is reconstructed. A major goal for ciphers designers, as set by Claude Shannon, father of information theory, is for ciphers to achieve so-called “semantic security”, or ciphertext indistinguishability under chosen-plaintext attack, in which no structure can be extracted from the ciphertext, even if some plaintext is known.

To keep messages confidential, the cipher designer must ensure that several ciphertexts from the same plaintext are different, thus diminishing the information recoverable by the cryptanalysts. Something must be added to ciphers to add variability to blocks of symmetric ciphers. The key is insufficient. This is achieved by adding parameters, sometimes called initialisation vectors, whose value and potential rules of change are inserted to the cipher algorithm. There are several types of techniques invented through time, so called “modes” in cryptologic jargon, to add such parameters or vectors: Electronic Codebook (ECB), Cipher Block Chaining (CBC), Propagating CBC (PCBC), Cipher Feedback (CFB), Output Feedback (OFB). These modes also sometime also need to validate the correctness of the received message blocks—its reception without errors—without which they do not work, which is why they integrate error correcting codes.

Most of these modes have proven to have significant weaknesses, which gave rise to new modes which were able to insure not only confidentiality but also the authenticity of their origin through with the addition of message authentication codes after each block— which by definition also ensure that error detection is automatic. Encryption modes standardized by ISO include for example OCB 2.0, Key Wrap, CCM, EAX, Encrypt-then-MAC (EtM), and Galois counter Mode (GCM).

The AES-GCM version of AES is for example currently supposed to be the most secure variant of the algorithm, which is why it was included in the HTTPS suite of cipher protocols. However, as the main cipher has become difficult to attach, the authentication tags themselves have now become the main target of attack for cryptanalysis, with particular attention given to the mode's initial values.

Keyed Message Authentication Function

In cryptography, an HMAC (sometimes expanded as either keyed-hash message authentication code or hash-based message authentication code) is a specific type of message authentication code (MAC) involving a cryptographic hash function and a secret cryptographic key.

A cryptographic hash function is a mathematical algorithm mapping a binary sequence of arbitrary size (often called the “message”) to a binary string of a fixed size (the “hash value”, “hash”, or “message digest”) and is a one way, that is, a function which is practically infeasible to invert. Cryptographic hash functions have many information-security applications, notably in digital signatures, message authentication codes (MACs), and other forms of authentication.

Message authentication codes may be used to simultaneously verify both the data integrity and the authentication of a message, as with any MAC. The cryptographic strength of the Keyed message authentication function depends upon the cryptographic strength of the underlying hash function, the size of its hash output, and the size and quality of the key. Keyed message authentication functions do not encrypt the message. Instead, the message (encrypted or not) must be sent alongside the Keyed message authentication function hash. Parties with the secret key will hash the message again themselves, and if it is authentic, the received and computed hashes will match.

Examples of keyed message authentication function and codes in wide use include HMAC-SHA256 or HMAC-SHA3, as part of both IPSec internet protocol and TLS web cipher suite.

Quantum Resistant Ciphers

Advances in the field of quantum physics and quantum computing will probably allow for the creation of all-purpose quantum computers. At the time of this writing, it is forecasted that before 2030, such computers will be able to break within very reasonable time-frames what were previously thought to be mathematical primitive constructions impervious to attack as used in commercial and industrial cryptography. Fibre optic networks, and associated photonic quantum encryption equipment are cost prohibitive to install everywhere. Their usage is limited to small secure local networks. They will not replace the existing copper-wire based networks deployed the world over in the near future. Meanwhile, to attack current encryption algorithms, L. K. Grover proposed a quantum search algorithm using known plaintexts in 1996, which quadratically diminishes the key search time for symmetric ciphers. Peter Shor has shown in 1999 already that quantum computers can factorize integers in linear time, rendering traditional public key cryptography algorithms completely ineffective to what is now called “Shor's Factoring Algorithm”. New solutions which are not based on physical phenomena were necessary.

A variety of alternative solution have been sought by researchers to build ciphers thought impervious to cryptanalysis with quantum computers: ciphers combining linear algebra over lattices with “learning-with-errors” algorithms, fundamentally are relying on the shortest or closest vector linear algebra problems with a unknown noisy function; code-based ciphers using error correcting Goppa codes; multivariate polynomials cryptography rely on the difficulty of solving such algorithm over finite fields; singular isogeny based ciphers have keys which describe transformation of singular elliptic curves into other such curves, onto whose values the plaintext is substituted. All these problems are currently though to be unsolvable using currently known mathematical techniques, or are based the current assumption that these problems cannot be solved efficiently in a practical time-frame by any kind of computer, classical or quantum. The government of the U.S.A. has for example started a program to standardize Post Quantum Cryptography, which is currently in its second round of selection. The 17 currently chosen candidates use problems based on lattices, codes, hashes, multivariate linear algebra, super singular elliptic curve isogeny and zero-knowledge proofs.

However, no such cipher provides a practical solution across all necessary usage scenarios. Lattice ciphers have for example large keys impractical for Internet of Things applications—i.e. generally than 4800 bits, but techniques to reduces these times have very long decryption times. Some code-based ciphers key sizes are too large for some applications: around 1 megabyte for public keys, while private keys are 11 kilobytes long and reducing key length makes these algorithms vulnerable to attacks. Only ECDH has an acceptable length of 32 bytes. A few multi-variate polynomial schemes have been broken. None of the above-mentioned ciphers support perfect forward secrecy—i.e. prevent that the compromise of one message or transmission session leading to compromise other such session. Isogeny-based ciphers, such as SIDH, while having short key sizes of 330 bytes, and supporting perfect forward secrecy, are however extremely slow: decryption necessitate 11-13 milliseconds on latest generation general purpose microprocessors. Memory usage can be extremely high (minimum 8406 bytes) for some algorithms, precluding their usage on low-end microcontrollers for Internet-of-Things applications. “A usability study of post-quantum algorithms” thesis by Marcus Kindberg at Lund University, Sweden, 2017 analyses and discuss these themes. These wide variety of practical usability issues have precluded any particular one to be used in commercial and industrial projects.

Logic Operators

Ciphers have historically been built using difficult numeric or polynomial problems, which usually lent themselves well to transformation into simple reliable linear mechanical, electromechanical or electronic circuits. Logic has generally been applied used in applying only the most basic Boolean logic algebra functions of binary addition (i.e. AND), binary negation (i.e. NOT), and exclusive and inclusive disjunction (i.e. XOR and OR) to sequences of bits, which it maps directly to basic electronic logic gates. Algorithms using that reduced logic can be implemented in relatively simple chips, and compact die sizes.

First order logic, also known as first order predicate logic or first-order predicate calculus, has as sixteen different canonically inference rules in its “propositional calculus” subset. Such rules, also called “logic operators”, or “logic connectives” are formalised in Boolean algebra (described in more detail later). Full first order logic is used in other fields, but not in cryptography.

### BRIEF SUMMARY OF THE INVENTION

It is the object of the present invention to find a cipher which can be computed efficiently, and which is quantum resistant.

This is solved by a method, apparatus or computer program according to the independent claims.

The use of more than the basic two or three logic operators in cipher allows a very strong protection against attacks, even when coming from quantum computers, and is on the other side very efficient to compute as they depend not on complex mathematical functions. Quantum computers are very good in solving algebraic problems, particularly when such problems are presented in polynomial form. All ciphers of the state of the art are built on algebraic functions and are thus vulnerable against quantum computer attacks. By building a cipher based on a set of first order logic functions allows to construct a cipher without using algebra and makes such ciphers very resistant against quantum computers.

This is solved by a method, apparatus or computer program in which a succession function for counting over elements is defined with at least two successors for one, more or each element, wherein the succession function is used for encrypting and/or decrypting an input message.

Having a succession function with two successors for an element, generated with a non-numeric symbolic logic generator and combined with contextual elements from the message, gives a non-algebraic succession function, which makes such ciphers very resistant against quantum computers. On the other side, the computation of such succession functions is fast.

This is solved further by a method, apparatus, computer program for encrypting and/or decrypting an input message using one or a combination of the subsequent embodiments.

The subsequent embodiments show further embodiments of the inventive solutions.

In one embodiment, at least five first order logic function from the existing sixteen first order logic functions are used for encrypting and/or decrypting an input message. In one embodiment, the sixteen first order logic functions comprise the following first order logic functions: Contradiction (FAL), Non-Disjunction (NOR), Converse Non-Implication (CNI), Left Projection (NP), Non-Implication (NIP), Right Projection (NQ), Exclusive Disjunction (XOR), Inclusive Disjunction (OR), Conjunction (AND), Equivalence (XNOR), Right Complement (RCM, Converse Implication (CIP), Left Complement (LCM), Implication (IP), Non-Conjunction (NAND) and Affirmation (TRUE). Importantly the inversion (NOT) is not a first order logic function. The first order logic functions can be realised by a combination of a subset of the sixteen first order logic functions, preferably a subset of at least six of the sixteen first order logic functions. The subset comprises preferably LCM, RCM, XOR, XNOR, NQ, NP. In one embodiment, each first order logic function defines four different results or truth values for the four different combinations of any two binary input values (first and second proposition) resulting in four different resulting binary output values (resulting truth values). Each first order logic function can be applied in three directions, a first direction with the first and second proposition as input values resulting in the corresponding resulting truth value, a second direction with the first proposition and the resulting truth value as input and the second proposition as output and a third direction, with the second proposition and the resulting truth value as input and the first proposition as output. In one embodiment, the sixteen or the at least six different first order logic functions define each a different set of four results for the four different combinations of the two binary input values. In one embodiment, at least six, preferably at least seven, preferably at least eight, preferably nine, preferably, at least ten, preferably at least eleven, preferably at least twelve, preferably at least thirteen, preferably at least fourteen, preferably at least fifteen of the sixteen first order logic functions are provided, and the input message is encrypted and/or decrypted based on the at least six, preferably at least seven, preferably at least eight, preferably nine, preferably, at least ten, preferably at least eleven, preferably at least twelve, preferably at least thirteen, preferably at least fourteen, preferably at least fifteen first order logic functions. In one embodiment, all sixteen first order logic functions are provided, and the input message is encrypted and/or decrypted based on the sixteen first order logic functions.

In one embodiment, a residual truth value is associated to each of the at least six first order logic functions. In one embodiment, said residual truth value is computed by another first order logic function associated in a pair with the first. In one embodiment, the residual truth value of each first order logic function comprises at least sixteen residual truth values. In one embodiment, each first order logic function defines four residual truth values computed by a first order logic function associated in a pair with the first, for the four different combinations of two binary input values (first and second proposition). Each of the at least six first order logic functions can thus be applied in at least sixteen directions. The application of the first direction of the first function of each first order logic function pair with the first and second proposition as input values results in the corresponding resulting truth value and the application of the first direction of the second function of each second function in the corresponding paired function results in a corresponding residual truth value. The application of one of the of each first order logic function pair with the truth value and the residual truth value as input and the first proposition and the second proposition results in a pair of truth and residual truth values as output. In one embodiment, the four residual truth values resulting from the four combinations of the two propositions are chosen as described in the following: for the first order logic functions NQ, XOR, XNOR, RCM randomly from the two four-tuples (1100) and (0011); for the first order logic functions NIP, NAND, AND, IP the first two residual truth values randomly from the four two-tuples (00), (01), (10), (00) and the last two randomly from the two two-tuples (01) and (10); for the first order logic functions NOR, CNI, CIP, OR the first two residual truth values randomly from the two two-tuples (01) and (10) and the last two randomly from the four two-tuples (00), (01), (10), (00); for the first order logic functions FAL, NP, LCM, TRU randomly from the four four-tuples (1010), (1001), (0110) and (0101). Randomly shall mean here that within the given rules, the two first order logic functions could have the same residual truth values. In one embodiment, the residual truth values computed by the associated first order logic functions depend on the cipher key.

In one embodiment, a generative logic ruleset is defined, wherein the generative logic ruleset comprises a logic set comprising the at least six first order functions, in at least two paired combinations of a first order logic function and its associated first order logic function used to compute the residual truth value, and a semiotic set comprising a number of symbols in a certain order, wherein the decryption and/or encryption of the input message is based on generative logic ruleset.

In one embodiment, the semiotic set is a list of different indexes referencing to the number of different symbols of a reference semiotic set of symbols containing the number of different symbols in a reference order, wherein the list of different indexes defines the certain order of the semiotic set. In one embodiment, the logic set is a list of indexes (each different) referencing to the at least six different first order logic function of a reference logic set containing the at least six different first order logic function in a reference order each an associated first order logic function used to compute the residual truth value, wherein the list of different indexes defines an order of the logic set. In one embodiment, the residual truth values represented by and first order logic function associated to the first logic function, associated themselves with the first order logic functions, are part of the generative logic ruleset and/or depend on the cipher key. In one embodiment, the semiotic set comprises the number of different symbols. In one embodiment, each symbol comprises a binary sequence of the symbol length, preferably the semiotic set comprises two power the symbol length different binary symbols in the certain order.

In one embodiment, the generative logic ruleset, the logic set and/or the semiotic set depends on the cipher key. In one embodiment, the certain order of the semiotic set depends on a cipher key.

In one embodiment, a pseudo-random symbol sequence is determined. In one embodiment, the pseudo-random symbol sequence depends on a cipher key. In one embodiment, an initialisation word is derived from the cipher key and the pseudo-random symbol sequence is derived from the initialisation word by an expansion function which increases the length of the pseudo-random symbol sequence compared to the initialisation word. In one embodiment, symbolic factoring is used as an expansion function, wherein symbolic factoring uses the logic set and the semiotic set to derive the pseudo-random symbol sequence from the initialisation word, wherein an input symbol sequence is based on the initialisation word, wherein symbolic factoring combines a first input symbol and a second input symbol of the input symbol sequence by a first order logic function selected for the combination of the two symbols to derive at least one output symbol, wherein an output symbol sequence is based on the at least one output symbol, wherein the pseudo-random symbol sequence is based on the output symbol sequence.

In one embodiment, the initialisation word is part of the generative logic ruleset. In one embodiment, the pseudo-random symbol sequence is a sequence of symbols with each symbol having a binary length of the symbol length (as defined in the semiotic set). In one embodiment, the pseudo-random symbol sequence has at least the length of the input message, preferably at least twice the length of the input message, preferably at least three times the length of the input message. Preferably, the length of the pseudo-random symbol sequence is chosen such that each symbol of the pseudo-random symbol sequence is used only once for encrypting or decrypting the same input message. In one embodiment, symbolic factoring combines the first input symbol and the second input symbol of the input symbol sequence by applying the first order logic function selected for the combination of the two symbols in the second direction to derive at least one output symbol.

In one embodiment, the symbolic factoring recursively repeats the process of combining two symbols out of the first input symbol, the second input symbol and of the at least one output symbols by a first order logic function further selected to derive further output symbols of the at least one output symbol (preferably the first order logic function applied in the second direction). Preferably, the symbolic factoring combines the first input symbol with the output symbol determined in the previous step (from combining the first input symbol and the second symbol or one of the output symbols resulting from this combination). In one embodiment, an expansion factor defines the number of repetitions of the recursive process applied for two symbols. Preferably, the expansion factor is part of the generative logic ruleset. Preferably, the expansion factor depends on or is derived from the cipher key. The symbolic factoring is repeated over all symbols of the input symbol sequence. Preferably, the symbolic factoring is started for a first symbol and a second symbol, continued for the second symbol and a third symbol, continued for the third symbol and a fourth symbol and so on, i.e. the symbolic factoring is performed between one symbol of the previous couple of symbols and a new symbol of the input symbol sequence. Preferably, the symbolic factoring is done on neighbouring symbols of the input symbol sequence, preferably starting from the beginning to the end. The symbolic factoring provides an output symbol sequence which is longer than the input symbol sequence. The output symbol sequence is preferably based on the output symbols and/or discards the inputs symbols. Preferably, the output symbol sequence is created by concatenating recursively the new output symbols at the start of the output symbol sequence already determined. In one embodiment, the symbolic factoring is performed on the initialisation word as input symbol sequence yielding an output symbol sequence and the symbolic factoring process is repeated recursively with the preceding/previous output symbol sequence as new input symbol sequence (until the pseudo-random symbol sequence results in a sufficient length). In one embodiment, the generative logic ruleset defines a logic function selection rule for symbolic factoring for selecting the first order logic function for each combination of two input symbols. Preferably, the logic function selection rule selects a first order function of the logic set for two input symbols depending on the position of one or two of the two input symbols and/or of the (edit) distance between the two input symbols in the semiotic set. In one embodiment, the logic function selection rule comprises a semantic generation root including at least one random number for each symbol in the semiotic set and one logic context including a list of references referencing each one of the first order logic functions of the logic set. The logic function selection rule selects a value in the semantic generation root (e.g. based on the position or distance) which indicates a reference in the logic context which indicates the selected first order function of the logic set for the two input symbols. In one embodiment, the value in the semantic generation root indicates an integer number indicating the number of positions to count in the logic context from the previous selected reference to the first order logic function. If the counter arrives at the end of the logic context, it counts further at the beginning of the logic context. In one embodiment, the position or distance determines the value of the semantic generation root at the index equal said position or distance. Preferably, the logic context comprises only a list of references to an arbitrary subset of the at least six first order logic functions. Thus, the logic context is preferably smaller than at least five. In one embodiment, a symbolic implicit inference factor defines the number of output symbols which are not recorded in the output symbol sequence of the symbolic factoring. Preferably, the symbolic implicit inference factor is part of the generative logic ruleset. Preferably, the symbolic implicit inference factor depends on or is derived from the cipher key. In one embodiment, the semantic generation root comprises symbolic implicit inference factor times the number of symbols in the semiotic set values. Preferably, the semantic generation root and/or the logic context is part of the generative logic ruleset. Preferably, the semantic generation root and/or the logic context depends on or is derived from the cipher key.

In one embodiment, decrypting and/or encrypting the input message comprises at least one processing step including processing an intermediate input message to obtain an intermediate output message, wherein the intermediate input message is based on the input message, wherein an output message of the decryption or encryption is based on the intermediate output message. Preferably, all, most or some of the intermediate input/output message(s) is stored and processed as intermediate message input/output symbol sequence. In one embodiment, symbols (in the intermediate message input/output symbol sequence) are stored and processed as references/indexes/integers referring to the corresponding symbol in the reference semiotic set or in the semiotic set. The processing of the symbols as symbols instead of as sequence of bits accelerates the processing and reduces the memory consumption. Preferably, the length in symbols of the intermediate message input symbol sequence corresponds to the length in symbols of the intermediate message output symbol sequence. Preferably, the method comprises a plurality of processing steps, wherein the length in symbols of the intermediate message input or output symbol sequence corresponds to the length in symbols of the intermediate message input/output symbol sequence of the other processing steps. However, the symbols can also be stored and processed as binary numbers or in many other ways to store and process symbols in the cipher and the symbol sequences is possible. Therefore, preferably the input message (which is normally a chain of character symbols, e.g. ASCII or UNICODE) is transformed in a sequence of symbols. The symbols can be stored e.g. simply by a reference to one of the indices/positions of the reference semiotic set or the semiotic set. For a symbol length of 4, each symbol can thus be represented by one of 16 values, e.g. by integers between 1 and 16 or 0 and 15. This reduces the memory consumption for the cipher significantly. When the cipher has finished, the output symbol sequence of the cipher can then be retransformed in the original format, e.g. in text character symbols.

In one embodiment, the at least one processing step comprises a structuring step. In one embodiment, the structuring step comprises for encrypting the input message the following steps: transform the symbols of the intermediate input message based on the semiotic set and/or the logic context and based on the pseudo-random symbol sequence into a transformed symbol sequence. Preferably, the transformation of the symbols of the intermediate input message is further based on an initialisation symbol sequence. In one embodiment, the structuring step comprises for decrypting the input message the following steps: retransform the symbols of the intermediate input message based on the semiotic set and/or the logic context and based on the pseudo-random symbol sequence into a retransformed symbol sequence. Preferably, the retransformation of the symbols of the intermediate input message is further based on an initialisation symbol sequence.

In one embodiment, the at least one processing step comprises a structuring step. The structuring step comprises for encrypting the input message the following steps: providing an initialisation symbol sequence; combining, preferably concatenating the initialisation symbol sequence with an intermediate input message of the structuring step to obtain a combined symbol sequence; and transforming the symbols of the combined symbol sequence based on the semiotic set and/or the logic context and based on the pseudo-random symbol sequence into a transformed symbol sequence, wherein an intermediate output message of the structuring step depends on the transformed symbol sequence. The structuring step comprises for decrypting the input message the following steps: providing an initialisation symbol sequence; determining a part of a retransformed symbol sequence based on the initialisation symbol sequence; retransforming the symbols of intermediate input message into the retransformed symbol sequence based on the semiotic set and/or the logic context and based on the pseudo-random symbol sequence, wherein an intermediate output message of the structuring step depends on the retransformed symbol sequence.

In one embodiment, an initialisation symbol sequence is provided. The initialisation symbol sequence is preferably derived from or depends on the cipher key, preferably the initialisation word, preferably the pseudo-random symbol sequence. In one embodiment, one symbol of the combined symbol sequence is transformed recursively based the one symbol of the combined symbol sequence, based on one symbol of the transformed symbol sequence, preferably the one symbol transformed in the previous recursion step, based on the semiotic set or the logic context and based on the pseudo-random symbol sequence. In one embodiment, one actual symbol of the combined symbol sequence is transformed recursively based the edit distance in the semiotic set between one symbol of the transformed symbol sequence, preferably the one symbol transformed in the previous recursion step, and one symbol depending on the actual symbol of the combined symbol sequence and depending on one symbol of the pseudo-random symbol sequence. In one embodiment, the intermediate output message of the structuring step depends on the last N symbols from transformed symbol sequence transformed last, wherein the number N corresponds to the number symbols of the intermediate input message of the structuring step. In one embodiment for decryption in the structuring step, one symbol of the intermediate input message is retransformed recursively based on the one symbol of the intermediate input message, based on one symbol of the retransformed symbol sequence, preferably the one symbol retransformed in the previous recursion step, based on the semiotic set or the logic context and based on the pseudo-random symbol sequence. In one embodiment for decryption in the structuring step, one actual symbol of the intermediate input message is retransformed based on the inverse function of the edit distance in the semiotic set between one symbol of the retransformed symbol sequence, preferably the symbol retransformed in the previous recursion step, and one symbol depending on the actual symbol of the intermediate input message and depending on a symbol of the pseudo-random symbol sequence. In one embodiment, the recursion direction of the encryption is opposed to the recursion direction of the decryption. If the encryption starts at the beginning and stops at the end of the combined symbol sequence, then the decryption starts at the end of the intermediate input message and stops at its end. Preferably, the initialisation symbol sequence is concatenated to the end of intermediate input message opposite to the end where the encryption recursion starts. In one embodiment, the intermediate output message of the structuring step of decryption depends on the last N symbols from the retransformed symbol sequence retransformed last, wherein the number N corresponds to the number symbols of the intermediate input message of the structuring step.

In one embodiment, the at least one processing step comprises a transposition step. The transposition step comprises for encrypting the input message the step of transposing symbols or bits of an intermediate input message of the transposition step based on the pseudo-random symbol sequence to obtain a transposed sequence, wherein an intermediate output message of the transposition step depends on the transposed sequence. The transposition step comprises for decrypting the input message the step of re-transposing symbols or bits of an intermediate input message of the transposition step based on the pseudo-random symbol sequence to obtain an intermediate output message of the transposition step.

In one embodiment, the transposition is performed by swapping two symbols (symbol-wise transposition). In another embodiment, the transposition is performed by swapping two bits (bit-wise transposition). Preferably, the transposition step goes through the symbols or bits of the intermediate input message and swaps the actual symbol or bit with another symbol or bit which has not yet been swapped/transposed. The symbol which is selected to be swapped with the actual symbol is chosen based on a swapping parameter. The swapping parameter comprises preferably a sequence of swapping parameters. Preferably, for each swapping action a new sapping parameter in the sequence of swapping parameters is used. Preferably, each swapping parameter of the sequence of swapping parameters corresponds to a symbol in the semiotic set or in the reference semiotic set. In one embodiment, the swapping parameter is based on the pseudo-random symbol sequence. In another embodiment, the swapping parameter is based on an authentication key. Thus, all symbols or bits are swapped at least once and/or only once and/or exactly once. Preferably, a set of attractor poles indicating a subset of positions/indices of symbols of the intermediate input message is generated based on the pseudo-random symbol sequence and the symbol selected for swapping or transposing is selected based on the set of attractor poles and/or the pseudo-random symbol sequence. Each attractor pole defines a starting point (a symbol or bit) in the intermediated input message for finding a symbol or a bit to be swapped. Preferably, a certain number of symbols or bits (greater than 2) are swapped based on the same pole, before a new pole is defined or calculated. The pole is preferably calculated based on the swapping parameter. In one embodiment, a succession function for counting is defined, wherein the succession function defines for different swapping parameters or symbols of the sequence of swapping parameters or for different positions at least two different successor symbols or different successor positions and a successor rule for deciding which successor symbol or position is currently applied. In one embodiment, the successor rule is that for each symbol or position there is a different the successors symbol or successor position are alternated. In one embodiment, the symbol or bit to be swapped with the current symbol or bit is based on the application of the successor function and the swapping parameter (of the current swapping step). In one embodiment, the swapping parameter of the current step provides a succession number, and the succession function is applied the succession number of times to yield a count number. The symbol or bit to be swapped with the current symbol or bit is preferably based on the count number. In one embodiment, the symbol or bit to be swapped with the current symbol or bit is preferably based on the symbol or bit of the previous swapping step and the count number, even more preferably the position or index of the symbol or bit to be swapped with the current symbol or bit is based on the position or index resulting from the position or index of the symbol or bit of the previous swapping step plus the count number. In one embodiment, the symbol or bit to be swapped with the current symbol or bit is based on the application of the successor function and the swapping parameter (of the current swapping step) and one of the attractor poles. In one embodiment, the symbol or bit to be swapped with the current symbol or bit is preferably based on the attractor pole and the count number, even more preferably the position or index of the symbol or bit to be swapped with the current symbol or bit is based on the position or index resulting from the position or index of attractor pole plus the count number. Preferably, when a new attractor pole is calculated, the symbol or bit to be swapped with the current symbol or bit is preferably based on the attractor pole and the count number, the subsequent symbols or bit to be swapped with the subsequent symbols depend on their symbol or bit swapped in the respective preceding swapping step and the count number determined in the respective swapping step (until a new attractor pole is calculated). Since the swapping depends just on the swapping parameter, e.g. the pseudo-random symbol sequence or the authentication key, it can easily be decrypted, if the receiver knows the swapping parameter, e.g. the pseudo-random symbol sequence or the authentication key. On the other side, the succession function with at least two successors introduces a high degree of nonlinearity which makes it very hard to crack a code based on this step.

In one embodiment, the succession function defines at least two successors and a rule for deciding under which condition which of the at least two successors is used. In one embodiment, the element is a symbol, preferably a symbol of the semiotic set or the reference semiotic set. In one embodiment, the element is an integer used for counting. The successor function is preferably used for counting over bits or symbols of an intermediate input message, preferably for counting over bits or symbols of an intermediate input message for transposing bits or symbols, preferably for swapping bits or symbols. The successor function defines for a, some or each element a first successor element and a second successor element, wherein the element, the first successor and the second successor are different from each other.

In one embodiment, the at least one processing step comprises a logic function step. The logic function step comprises for encrypting the input message the following steps: providing a logic function pair; transforming a logic function message based on the logic function pair series into a transformed logic function message with residual truth values associated to each symbol of the transformed logic function message, wherein an intermediate output message of the logic function pair step for encryption depends on the transformed logic function message, wherein the logic function message depends on an intermediate input message of the logic function pair step for encryption. The logic function pair step comprises for decrypting the input message the following steps: providing a logic function pair series which is bijective to the encryption logic function pair series; re-transforming a transformed logic function message based on the bijective logic function series into a logic function message, wherein an intermediate output message of the logic function pair step for decryption depends on the logic function message, wherein the transformed logic function message depends on an intermediate input message of the bijective logic function pair step for decryption.

In one embodiment, the logic function pair series in the encryption step and in the decryption step must be the complementary and bijective. In one embodiment, both logic function series depends on the cipher key, preferably on the pseudo-random symbol sequence. Preferably, each logic function entry of each logic function series depends on a different symbol of the pseudo-random symbol sequence. In one embodiment, both logic function series comprises a series whose elements are selected out of the at least six first order logic functions. The elements of the logic function series comprise preferably references to the first order logic functions of the logic set or the reference logic set. The logic function series could be calculated once and then used in the subsequent steps or the logic function series could be calculated “on the fly” such that in each step the corresponding logic function of the series is calculated or such that for a number of steps the corresponding logic functions of the series are calculated.

In one embodiment, the logic function message depends on the intermediate input message of the logic function step for encryption and the initialisation symbol sequence, preferably on the concatenation of the initialisation symbol sequence and the intermediate input message of the logic function step for encryption. In one embodiment, the intermediate output message of the logic function step for decryption depends on and on the initialisation symbol sequence, preferably on the logic function message without the initialisation symbol sequence. In one embodiment, the intermediate output message of the logic function step for encryption depends on the last logic number of symbols or bits of the transformed logic function message, wherein the logic number of symbols is equal to the number of symbols or bits of the intermediate input message. The other symbols or the first symbols are discarded. In one embodiment, the transformed logic function message depends on the intermediate input message of the logic function step for decryption.

In one embodiment for encryption, the transformed logic function message is based on the logic function pair series, the residual truth values associated with the first order logic functions of the logic function series and the logic function message. In one embodiment, the values of the transformed logic function message are determined recursively. In each recursion step for encryption, the logic function series provides a new first order logic function. Since the first order logic functions are pseudo-randomly selected, the first order logic functions of two subsequent steps can be the same or different. Two input values of the current recursion step are used to determine based on the first order logic function of the current recursion step two output values. Preferably, the first order logic functions are applied in the first direction resulting in a first output value depending on the truth values of the first order logic function of the current recursion step and the second output value on the residual truth values of the first order logic function of the current recursion step. Preferably, the first input value acts as the first proposition for the first order logic function and the second input value acts as the second proposition for the first order logic function. However, the first order logic function could be applied in a different direction, which however complicates the algorithm. The first input value of the current recursion step depends preferably on the second output value of the previous recursion step. Preferably, the first input value depends preferably on the second output value of the previous recursion step and a context value from the current recursion step determined from the cipher key, preferably from the pseudo-random symbol sequence. Preferably, the context value is a new context value in each recursion step (but could in some cases have the same value). Preferably, the first input value of the current recursion step depends on an XOR combination of the second output value of the previous recursion step and the context value from the current recursion step. The second output of the first order logic function of the current step is used then for the next recursion step. The transformed logic function message depends on the sequence of the first output values provided by the sequence of recursion steps. The second input value is based on a value of the logic function message of the current recursion step. The logic function step for encryption gives further out the second output value of the last recursion step. This second output value of the last recursion step given out is also called decryption initialisation value. The other second output values can be discarded. For the first recursion step, the first value of the intermediate input message or of the initialization symbol sequence can be used as second output value of the previous recursion step.

In one embodiment for decryption, the logic function message is based on the logic function pair series, the residual truth values associated with the first order logic functions of the logic function series and the transformed logic function message. In one embodiment, the values of the transformed logic function message are determined recursively. In each recursion step for decryption, the logic function series provides a new first order logic function. Since the first order logic functions are pseudo-randomly selected, the first order logic functions of two subsequent steps can be the same or different. Since the first order logic functions are pseudo-randomly selected and can be retrieved from the cipher key, the bijective logic function pair series can be used for decryption as for encryption such that the same first order logic function is used in corresponding values or recursion steps of the encryption and decryption. Two input values of the current recursion step are used to determine based on the first order logic function of the current recursion step two output values. Preferably, the first order logic functions are applied in the fourth direction resulting in a first output value depending on the first proposition of the first order logic function of the current recursion step and the second output value on the second proposition of the first order logic function of the current recursion step. Preferably, the first input value acts as truth values for the first order logic function and the second input value acts as the residual truth values for the first order logic function. However, the first order logic function could be applied in a different direction (but the direction should be the inverse of the direction used in the encryption), which however complicates the algorithm. The second input value of the current recursion step depends preferably on the first output value of the previous recursion step. Preferably, the second input value depends preferably on the first output value of the previous recursion step and a context value from the previous recursion step (determined from the cipher key, preferably from the pseudo-random symbol sequence). Preferably, the context value is a new context value in each recursion step (but could in some cases have the same value). The context value is the same for corresponding steps in encryption and decryption. Preferably, the second input value of the current recursion step depends on an inverse XOR combination of the first output value of the previous recursion step and the context value from the previous recursion step. The first output of the first order logic function of the current step is used then for the next recursion step. The transformed logic function message depends on the sequence of the second output values provided by the sequence of recursion steps. The logic function step for decryption receives as a further input a decryption initial value which is used for determining the second input value of the first order logic function for the first recursion step.

The second input value is based on a value of the logic function message of the current recursion step. The value can be a bit or a symbol. If the value is a bit, the logic function message is transformed bitwise. If the value is a symbol, the logic function message is transformed symbol-wise, i.e. that the same logic function of the current recursion step is applied bitwise on all bits of the two input symbols.

In one embodiment, the at least one processing step comprises for encryption one or more of the following steps: a structuring step, wherein an intermediate input message of the structuring step depends on the input message or one of the intermediate output messages of previous steps; a first transposition step, wherein an intermediate input message of the first transposition step depends on the input message or one of the intermediate output messages of previous steps; a logic function step, wherein an intermediate input message of the logic function step depends on the input message or one of the intermediate output messages of previous steps; a second transposition step, wherein an intermediate input message of the second transposition step depends on the intermediate output message of the logic function step and on a hash resulting from one of the previous intermediate input messages or one of the previous intermediate output messages and/or on an further decryption initialization value output from the logic function step.

In one embodiment, the at least one processing step comprises for decryption one or more of the following steps: a second transposition step, wherein an intermediate input message of the second transposition step depends on the input message or a previous intermediate output message, wherein an intermediate output message of the second transposition step and a decryption initialisation value and/or a hash is given out from the second transposition step; a logic function step, wherein an intermediate input message of the logic function step depends on the intermediate output message of the second transposition step and the decryption initialisation value; a first transposition step, wherein an intermediate input message of the first transposition step depends on the input message or a previous intermediate output message; a structuring step, wherein an intermediate input message of the structuring step depends on the input message or a previous intermediate output message, wherein the output message depends on the intermediate output message of one of the previous intermediate output messages.

Preferably, the hash is calculated based on an authentication key. The hash can be used to authenticate the message. By mixing the hash in the output message of encryption, i.e. in the cipher text, it is very difficult for attackers to use the hash for cracking the cipher. Also, the decryption initialisation parameter is mixed in the output message of the encryption, so that it is very difficult for an attacker to find the starting point for the recursive method of the logic function step. Preferably, the swapping parameter of second transposition step depends on the authentication key. Preferably, the swapping parameter of first transposition step depends on the cipher key, preferably on the pseudo-random symbol sequence. Preferably, the second transposition step is performed such that the swapping is performed bitwise. Preferably, the first transposition step is performed such that the swapping is performed symbol-wise.

In one embodiment, the encryption and/or decryption is symmetric or asymmetric.

### BRIEF DESCRIPTION OF THE DRAWINGS

The invention will be better understood with the aid of the description of an embodiment given by way of example and illustrated by the figures, in which:

FIG. 1 shows a schema of an embodiment of the cipher for encryption

FIG. 2 shows a complete first order predicate logic truth table

FIG. 3 shows a general schema for symbolic factoring

FIG. 4 shows a non-ordinal succession function affinity matrix and graph

FIG. 5 shows how a non-ordinal affinity matrix is constituted

FIG. 6 shows an example of a transposition using the non-ordinal function

FIG. 7 shows an example of base semiotic set of binary symbols set 4 bits long

FIG. 8 shows a standard first order logic connector set

FIG. 9 shows an example segmentation of a cipher key

FIG. 10 shows a secret semiotic set of binary symbols

FIG. 11 shows a secret logic connector set

FIG. 12 shows an example complete residual set truth table

FIG. 13 shows a logic context set

FIG. 14 shows a semantic root matrix

FIG. 15 shows the diagram of the symbolic factoring algorithm

FIG. 16 shows a non-ordinal selection algorithm diagram

FIG. 17 shows an example of encryption using generative logic

FIG. 18 shows an example of decryption using generative logic

### DETAILED DESCRIPTION OF AN EMBODIMENT OF THE INVENTION

First, one exemplary embodiment of the method of the invention will be presented. Second, some general concepts and terms of the invention will be described and/or defined. Third, the individual steps of the embodiment of the invention will be described in more detail.

### One Exemplary Embodiment of the Method of the Invention

The method of the invention describes the encryption and/or decryption of a message m exchanged between at least two subjects. A first subject encrypts the message and sends the encrypted message to a second subject which decrypts the encrypted message to obtain the original message m. The first subject is preferably an apparatus configured for encrypting the message m as described in the following and giving out the encrypted message m, preferably sending the encrypted message m to the second subject. The second subject is preferably an apparatus configured for receiving the encrypted message and/or decrypting the encrypted message to obtain the original message m as described in the following. The sending of the message m from the first to the second subject can be by any way including a network like LAN, WLAN, internet, mobile phone network, LORA or including also the physical transport of the encrypted message e.g. via a data storage. The first and second subject are preferably both configured to act as first or second subject, i.e. being configured to encrypt a message m and to decrypt an encrypted message. The apparatus of the first and/or second subject comprises each preferably a communication section and a processing section. The communication section being configured for receiving an encrypted message and/or for giving out the encrypted message. The processing section is configured for processing the described steps of encryption of the message m and/or for the decryption of the encrypted message m. The processing section can be a general-purpose processor like a CPU, a processor for encryption/decryption, a chip for executing just this encryption and/or decryption or any other processing means. The processing section could also comprise a plurality of sub-processing section as used in multi-core processors (each core being a sub-processing section) or in cloud-computing (each processor being a sub-processing section). It shall be distinguished in the following the cipher scheme and the cipher case. The cipher scheme defines the cipher parameters and methods independent from any inputs. This would correspond normally to the software installed on an apparatus to define the apparatus as first and/or second subject. The cipher case is defined by the cipher scheme plus the first level inputs. The cipher case defines the realisation of the cipher scheme between a group of at least two subjects defined by the first level inputs. The method will be described just for two subjects. It is clear that the first subject could communicate with the present cipher (encryption/decryption scheme) to multiple second subjects instead of just one second subject.

Given
a set “A_{B}” of symbols, ordered and indexed by “u”, each encoded as a short binary sequence of length “b” (preferably b≥4), and stored in memory.
a set “L_{B}” of memory addresses for the 16 1^{st} order logic functions, each stored in memory represented as a sequence of microcode instructions for the invention's system's processor, ordered and indexed by “v”, arranged in standard order of the values in binary base numerals of the representation of each function's it's truth table.
A keyed message authentication function for the message m, using a key kₐ resulting in an Message Authentication Tag(“MAC”) h such as HMAC (m, kₐ)=h, represented as a binary sequence, or any other function using at least the m and kₐ as parameters, preferably represented as a sequence of microcode instructions for the invention's system's processor.

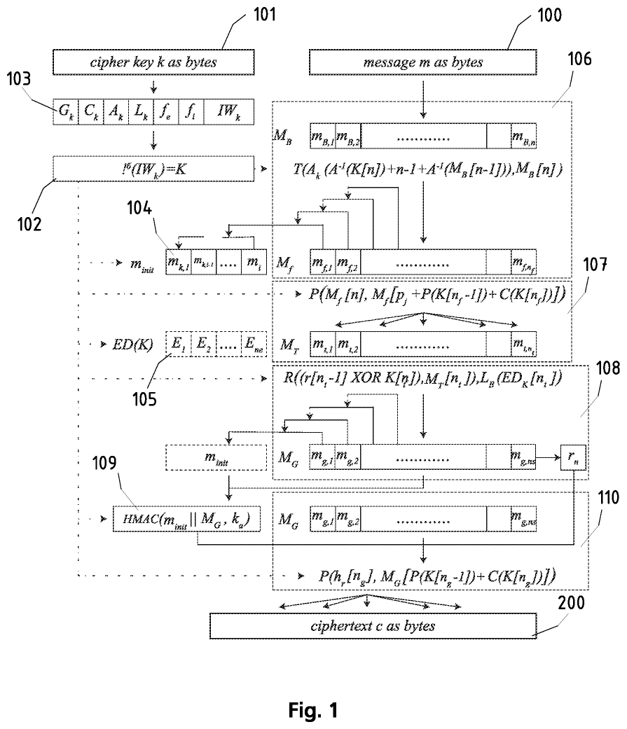

Inputs
a message “m” (element 100 in FIG. 1) as a binary sequence of length preferably l(m)≥768 bits.
a cipher key “k” (element 101 in FIG. 1) as a binary sequence of length l(k)≥256 bits, preferably 1(k)≥512).
An authentication key “kₐ”, for use in a keyed authentication function (i.e. HMAC)

Preparation of Generative Logic Ruleset (3)

k is segmented into several parameters and data structures, stored in random access memory (graphically represented by object 103 9n FIG. 1):
a secret semiotic set “Aₖ” of binary sequence of length “b”, of 2^{b} el. as unique randomly arranged values between 1 and 2^{b}, corresponding to index u of A_{B};
a secret logic set “Lₖ” of 16 elements as unique randomly arranged values between 1 and 16, each corresponding to a unique element index v of L_{B};
a secret residual set “Rₖ” of 16 elements sequences of supplementary truth value each corresponding to a unique element index v of L_{B}, used to compute “residual” bits for each function of Lₖ, encoded as sequences of 4 bits in length;
a secret generative context “Cₖ” as a sequence of random values between 1 and 16, each corresponding to an element index c of Lₖ;
a symbolic expansion factor “ƒₑ”, as a numeric value;
a symbolic implicit inference factor “ƒᵢ”, as a numeric value;
a semantic generation root “Gₖ”, as an array of numeric values different than l(Cₖ);
an initialisation word “IWₖ”, as a random sequence of bits.

The elements above are accompanied by a selection function. Some are accompanied as well by an inverse bijective resolution function (i.e. given a function of Lₖ, or Rₖ, a given answer, and given only one of the initial elements used in said function, it returns the other used element's index): Aₖ(a) and Aₖ⁻¹(a), L_{B}(v), Lₖ(w) and Lₖ⁻¹(w), Cₖ(c), Gₖ(o,p), Rₖ(p1,p2) and Rₖ⁻¹(r,s, ƒ)—the last two respectively returning the symbol pair which, given a function ƒ, a result s, and a residual r, when ƒ was applied to said symbols, resulted in truth s and residual r.

Setup for the Cipher

Segment m in short sequences of length b; then map each one to its symbol index in A_{B} using B(m;A_{B})=m_{B}, indexed by n_{b} and with a selection function M_{B}[n_{b}]; then, (1)

Derive a pseudo-random symbol sequence “K” from IWₖ, (102 in FIG. 1) segmented into symbols of length b as I_{B}, using symbolic factoring within the context of Lₖ, Cₖ, Gₖ, ƒₑ and ƒᵢ using !ₖ^{σ}(I_{B})=K applied recursively in nₖ iterations over I_{B}∀[(l(m_{B})/ƒₛ)+nᵢ]≥nₖ≥(6×l_{ƒ}), as well as any intermediary sequence thus generated. The K sequence is indexed by nₖ with a selection function K[nₖ]; any given symbol in a given K sequence may only ever be used once in the cipher operations below; then,

Segment an “mᵢₙᵢₜ^{”} initialization symbol sequence from K such as mᵢₙᵢₜ=(m_{k,1}, m_{k,2}, . . . , m_{k,n}_{ᵢ})∀[(m_{k,n}∈A_{B})∧(1≥nᵢ≥l(mᵢₙᵢₜ))], (104 in FIG. 1) with preferably l(mᵢₙᵢₜ)<2^{b}. Then, applying to successive pairs of elements of mᵢₙᵢₜ, and resulting intermediary sequences functions from L_{B} selected by L_{B}(L|k(C|k(nᵢ))) until only two symbol m_{i,1} and m_{i,2} remain; then,

Compute a generative logic function sequence “ED_{K}” (105 in FIG. 1) by mapping each element of K to the corresponding index represented by said symbol of K within Lₖ and the truth values within Rₖ, ED_{K}=Σₙ_{ₑ}₌₁ⁿ^{ᵢ}^{l}^{_{ƒ}}(Lₖ⁻¹(K[nₑ]); Rₖ(Lₖ⁻¹(K[nₑ]))); ED_{K} indexed with nₑ, and a selection function E(nₑ).

Encryption
Transform m_{B} into a structuring sequence “M_{ƒ}”, (106 in FIG. 1) which for m_{B}'s symbols produces a sequence M_{ƒ} with which m_{B} can be reconstructed relative to a secret alphabet Aₖ and a context K. and mᵢₙᵢₜ and m_{B} are first concatenated, and then, using the function T with parameters Aₖ, m_{B}+mᵢₙᵢₜ[n−1], m_{B}+mᵢₙᵢₜ[n], K[n], which returns the edit distance between symbols a₁, a₂, and a given symbol given by K, in Aₖ. The resulting recursive sequence Σₙ_{_{ƒ}}₌₁ⁿ^{_{ƒ}}^{-l}^{_{ƒ}}T is computed with l_{ƒ}=l(mᵢₙᵢₜ)+l(m_{B}); only the last l(m_{B}) elements in the sequence are recorded in M_{ƒ}. M_{ƒ} is indexed by n_{ƒ}, and accompanied by a selection function M_{ƒ}[n_{ƒ}]; then,
Transpose the elements of M_{ƒ} into a sequence “M_{T}”, (107 in FIG. 1) using a symbol selection function mapped over M_{ƒ} by a totally ordered set T, generated from k, and contextually evolving over K. The symbols of M_{ƒ} are sequentially permuted around a set of poles “p” whose relative position over M_{ƒ} is generated by K, using the attractor function P(M_{ƒ}[n_{ƒ}],M_{ƒ}[pⱼ+P(K[n_{ƒ} −1])+C(K[n_{ƒ}])]). M_{T} is indexed by nₜ and accompanied by a selection function Mₜ[nₜ].
Infer a symbol sequence M_{g} using the generated logic sequence ED (108 in FIG. 1) by sequentially applying the logic function pair sequence ED_{K} recursively to M_{T} using an application function R(K, Mₜ, E, nₜ) such as R((rₙ_{_{t−1}} xor K[n]), Mₜ, E[nₜ])=(M_{g}[nₜ]; rₙ_{ₜ}), with r₀=m_{i,1}, so that a resulting sequence M_{g}, indexed by n_{g} and accompanied by a selection function M_{g}[nₕ], which is computed recursively by M_{g}=Σₙ_{ₜ}₌₁ⁿ^{ₜ}^{=l}^{_{ƒ}}[R(K, Mₜ, E, nₜ)∨r(K, Mₜ, E, nₜ−1)], discarding all rₙₜ symbols but recording the last rₙ in memory. Symbols of M_{g} and rₙ may be substituted by equivalents in Aₖ; then,
Calculate the authentication tag h for M_{G} (109 in FIG. 1) using the given function HMAC (m, kₐ)=h substituting m for M_{G} concatenated with mᵢₙᵢₜ, so that h=HMAC((M_{G}∨mᵢₙᵢₜ), kₐ). kₐ may alternatively be given in embodiments another value, such as a segment of K of sufficient length; then,
Transpose the concatenation of the h authentication tag and rₙ into M_{G}, (110 in FIG. 1) using the same transposition as for M_{T} above, except in this case transposing bits of the concatenation (h∨rₙ)=hᵣ within M_{G}, using the modified transposition function P(hᵣ[n_{g}], [P(K[n_{g}−1])+C(K[n_{g}])]), thus forming the final ciphertext sequence c, (200 in FIG. 1) which can be then recorded as bytes ready for storage or transmission.

Decryption
Perform all the steps above from ‘preparation’ to ‘setup of a cipher’; then verify the authentication tag h with kₐ, M_{g} and mᵢₙᵢₜ, by reconstituting the transposition sequence using the corresponding segment of K used to transpose from h and rₙ to c originally, then by permutating bits in inverse order to recover these two concatenated sequences along with M_{g}, then verify h; if it succeeds, segment M_{g} in symbols of length b; if it fails, stop decrypting; otherwise,
Deduct Mₜ from M_{G} using the generated logic sequence ED by recovering each intermediary (rₙ_{_{g}}₋₁ xor Kₙ_{_{g}}) symbol from the former sequence by recursively applying the Rₖ⁻¹ (rₙ_{_{g}}, M_{g} [n_{g}], E[n_{g}]) (Mₜ[l_{ƒ} −n_{g}]; (rₙ_{_{g}}₋₁ xor K[n_{g}])) inverse bijective resolution logic function pair to each (r, s) pair of M_{g}, starting from the recovered rₙ and the last symbol s of M_{G} to the first symbol sₙ of M_{G}, for 1≤nₜ≤l(M_{G}). Then, in turn, recover the preceding r for the next s symbol by applying the inverse resolution function S_{L,1}⁻¹(K[n_{g}], (rₙ_{_{g}}₋₁ xor K[n_{ƒ}]),XOR); then,
Transpose M_{G} back to M_{ƒ} back by reconstituting the transposition sequence using the corresponding segment of K used to transpose to M_{G} originally, then perform the permutations in inverse order to recover M_{ƒ}; then
Reconstruct m_{B} from the restructuration sequence “M_{ƒ}” according to a context Aₖ, by generating using K the sequence of symbols M_{d}=Σₙ_{_{d}}₌₁ⁿ^{_{d}}^{=l(S|d)} Aₖ(Aₖ⁻¹(K[n_{d}])+n_{d-1}), with accompanying selection function M_{d}[n_{d}]; then reconstituting m_{B} starting with from the last symbol in M_{ƒ}, recovering m_{B} with T⁻¹(Aₖ; M_{d}[n_{d}]−M_{ƒ}[n_{d}−1]; M_{ƒ}[n_{d}]) m_{B} [n_{d}]; then combine symbols of m_{B} in pairs to recover the message m.

The invention allows for a much-increased level of security compared to existing cipher, allowing for the diffusion of an authenticated encryption tag without the danger of exposing any information of the underlying message and providing quantum-computer driven cryptanalysis resistance using Shor's or Glover's algorithms.

General Principles

Logic and Indeterminacy of Statements

The mathematical building blocks used in modern cryptography are mostly based on mathematical problems which are difficult to solve—i.e. there ought to be no known algorithms usable to find the answer to said problem with a computing machine within a practical time span. A practical rule of thumb if that any known resolution algorithm's time approaches the number of time necessary to enumerate all possible cipher keys, to attack it with “brute force”, then it is judged to be a good cipher.

Ciphers have historically been built using difficult numeric or polynomial problems, which usually lent themselves well to transformation into simple reliable linear mechanical, electromechanical or electronic circuits. Logic has generally been applied used in applying only the most basic Boolean logic algebra functions of binary addition (i.e. ADD) and exclusive disjunction (i.e. XOR) to sequences of bits, which it maps directly to basic electronic logic gates. Algorithms using that reduced logic can be implemented in relatively simple chips, and compact die sizes.

Logic is an interpretative tool of reason. Until recently, with computing power being scarce, in addition to expensive transmission bandwidth and chip engineer time, no logic more advanced has been used in cryptology. Any computing tool using logic could implementing logic reasoning concepts: inference, induction, deduction, amongst many others. Such logic concepts cannot however be trivially implemented with logic gates in simple circuits with no memory or use of recursion, but require a complete Turing machine. Advanced uses of logic have thus been eschewed by cryptology researchers.

Moreover, logic is a tool for understanding. With the work of Gödel, a century ago, new dimensions of thought had to be included to the logician's toolbox, amongst which the decidability, indeterminacy and computability of statements. His incompleteness theorem states a consistent formal logical or axiomatic system cannot be complete, and that the consistency of axioms cannot be proved within their own system. Many new logic frameworks have been constructed afterwards, with amongst other goals to study logic systems, and how to solve statements within such systems. Such concepts are of chief importance in computer science, and should be even more so in cryptology, which could be said to be the science of selective misunderstanding.

First Order Logic

First order logic, also known as first order predicate logic or first-order predicate calculus, has as sixteen different canonically inference rules in its “propositional calculus subset. Such rules, also called “logic operators”, or “logic connectives” are formalised in Boolean algebra. Boolean algebra is well adapted to application as binary logic in electronic hardware, whereas a value of True for a predicate is represented as a “1” and the False value of a predicate is represented as “0”.

Amongst such operators, implemented as Boolean functions, are for example are TRUE (affirmation), FALSE (contradiction), NEITHER OR (non-disjunction), etc. All such operators can be decomposed combinations of the most basic AND, OR, and NOT functions, expressible as the simplest digital logic gates in electronic hardware.

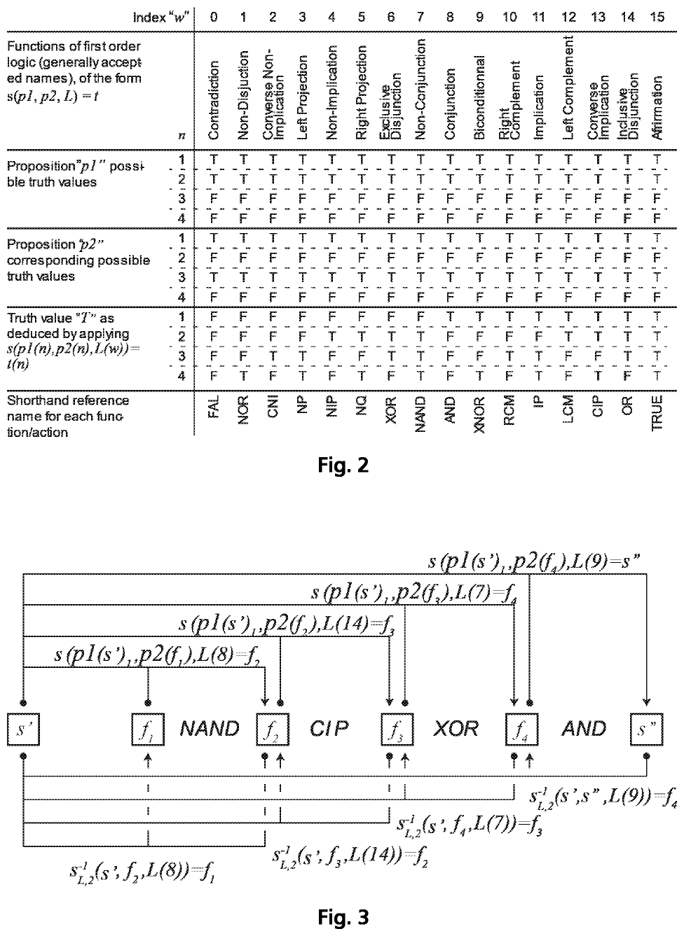

The result of the application of such operators to two given predicates p1 and p2 can be found using a so-called “truth table”, which can be technically implemented as a lookup table, accessed with an application function s(p1(n), p2 (n), L (w))=T (w, n) accessing said lookup table. FIG. 2 shows the canonical truth table for first order predicate logic.

For example, for a given p1 predicate which is True, and a given p2 predicate which is false, to which a non-implication is applied, n=2,u=5, using the lookup function s(p1(2), p2(2), L(5))=T(5,2) to access the lookup table at the(w,n) coordinates of the truth table, giving a value of T, which equals True.

For a given logic function L(w), a given proposition p1(n), and a Truth value T (w, n), one can find the correct truth value of p2 with inverse resolution function of the form s_{L,2}⁻¹(p1(n), T (n), L (w))=Q (n), in which one looks up the table the same way as above. Similarly, for a given logic function L(w), proposition p2(n), and Truth value T(w, n), one can find the p1 truth value with an inverse resolution function of the form s_{L,1}⁻¹(p2(n), T(n), L(w))=p1(n), by looking up the correct value.

For each such function, embodiments store a list of possible result depending on the two sets of input bits in the system's processing unit registers or in memory locations as lookup tables, outputting the results in a third either processing unit register or memory location, which are either “0” bits corresponding to the “false” values, or “1” bits corresponding to “true” values, or, in some embodiments, as a numeric value unique corresponding to the binary value of each result for each such function.

In embodiments, such functions are represented in memory either as sequences of microcode instructions for the invention's system's processor, or as sequences and combinations of the most basic logic functions or the minimum set of logic gates (AND, OR, NOT), operating over two central processing unit registers, providing the result in a third register.

Generating a Logic System

Cryptanalysis techniques are by definition deductive processes. With this invention, we aim to generate a logic system using the cipher key characterizable as a tautology. This logic system is then applying it to the message using the methods of the invention to create a construction which is not logically decidable in polynomial time using traditional cryptanalysis techniques.

Without the cipher key the ciphertext, as a tautology constructed using both the message and logic system, is incomplete and fully undecidable. Even when inferring logic systems, without having the key, and performing known plaintext attacks, the attacker must to generate all possible of logic systems which can explain a given ciphertext or portion thereof. This requires memory which grows more than exponentially with both the possible number of permutations and substitutions. The coherence of each system must be checked against the known plaintext, consequently making even differential and known plaintext attacks very difficult in polynomial time.

As generated by the methods of this invention, such systems can only be completed and become by definition complete, coherent, consistent and congruent when using the cipher key with the methods of this invention to complete the system implicitly defined by the ciphertext. Moreover, if the basis for the construction of the logic system is not numeric, there are no systems of equations, linear or affine maps constructible, precluding the use of Shor's algorithm. If the “hidden” variable in the case of Grover's algorithm has the same length as the message, and has no classical numeric basis, then neither is that latter algorithm applicable. The only remaining method available to is thus a brute force enumeration of all possible keys.

To achieve these goals, using the methods of this invention, we create a sequence of a length greater than the message derived from the cipher key. The technique is the technique of symbolic factoring, also invented by the authors of this invention to derive a stream from the cipher key (see further below). The result is to create a pseudo-random sequence of symbols. Each symbol is then used only once in the cipher and used as parameter either on a first order logic operator, a transposition function or a structuring substitution function, as applied each symbol of a message or smaller.

In effect, a single sentence in a logic language and system generated by key, i.e. tautology, is created, and has the same size or greater than the length of the message. That sentence is used to both encrypt and decrypt said message, as defined by the methods of this invention.

As the methods of this system are executable in fixed deterministic number of steps, the logic systems created by the methods of this invention can be used as a standalone cipher, or, alternatively as a counter mode for any existing cipher, such as AES or ChaCha20.

Symbolic Factoring

Given two symbols from a given alphabet, not taken as numbers, but as a combination within a given coherent logic system, the goal of symbolic factoring is to compute, given a valid statement in a given logic system using said alphabet, a sequence of symbols which can, when combined with said logic statement and the two starting symbols, form a coherent, congruent and consistent logic system, with each symbol representing a given predicate within said system.

In more practical terms, for any two given symbols, this signifies the goal is to find the suite of symbols which, when used in conjunction with a sequence of logic connective, combine to the two above-mentioned symbols when following said connectives.

Symbolic factoring takes numbers (or binary sequences as bytes), not by their numeric value, to which a classical factoring algorithm is applied resulting in the smallest possible factors, but as symbol conjunctions. By that logic, in a simplistic example, one could factor the symbol combination “17” as the list of symbols within its “alphabet” of definition, the Arabic numerals, displayed in standard increasing or decreasing order of their numeric value, which would be the conjunction logic, in which case the factors would be {2,3,4,5,6}, or for the symbolic factor 84 the result would be {7,6,5}.

This factoring algorithm is not numeric either, i.e. as the inverse of multiplication, instead purely semiotic as an “inverse” of symbol combinations rules, which are based on first order logic. Consequently, to factor a symbol pair s′ and s″, taken both as symbols represented by binary sequences of the same length, the goal has to find the sequences of symbols, each of which, in turn, according to given sequence of logic connectives, given a s_{L,2}⁻¹(n), T(n), L(w))=p2(n), and applied a given number of times equal to the number of logic connectives—hereafter called the “expansion factor”. One can also choose to perform a fixed additional symbolic factorisation between each selected factor, but not record such factors, the amount of which is called the “implicit factor”.

The logic sequence is called the logic context of the symbolic factoring. FIG. 3 illustrates a sequence of a symbolic factoring of two symbols with an expansion factor of 4 and an implicit factor of 0, with a logic connective sequence of (NAND, CIP, XOR, AND), using the function s_{L,2}⁻¹( ). Starting from s′ as p1( ), s″ as T( ), symbolic factor ƒ₄ instead of p2( ), one applies the s_{L,2}⁻¹( ) recursively substituting ƒ₄ to T( ), ƒ₃ to p2( ), and so on and so forth until ƒ₁ is finally computed for the full factor sequence with expansion factor 4. One can check the correctness of the symbolic factoring by directly applying the chain of logical operators/connectors in the opposite order until s″ is finally computed.

Expanded Key Derivation by Symbolic Factoring

As for practical purposes, the length of any cipher key ought to be kept short, between 256 and 512 bits, so it can be agreed upon over communication mediums with limited frame size. We have to derive a stream of symbols from the cipher key. The invention described herein does however not use traditional key derivation methods such as Bcrypt, Scrypt, HKDF, or even ChaCha20, if used in such a fashion. ChaCha20 can generate a number of streams equal to 2 at the 64th power, with each stream cycling with the counter, 2 at the 32nd times 512 equalling 256 Gigabytes, as used in TLS, depending on implementations.

The methods of the invention use as the method for deriving an expanded sequence, hereafter called “K”, from a short relatively short key the method of “symbolic factoring”, as outlined above, and previously developed by the authors of this invention. Its use is completely novel in cryptography. The authors believe is has very good characteristics for use in modern cryptography, amongst which a much longer cycle before repetition than for example ChaCha20.

Depending on the embodiments of this invention, the number of streams is the power of two equal to the number of bits of the key, and the cycle is larger by several orders of magnitude. Key derivation function based on hashes “lose” information; most other functions create what in effect are polynomials structures which have an intrinsic structure—an implicit information in and of itself. Symbolic factoring generates a sequence of symbols as a non-contextual language, built for all practical purposes as an aperiodic semantic combination set of rules. As the factoring rules are not numeric, they are directly indeterminate for any given symbol sequence as per both Gödel and Kolmogorov, in relation to the generalized word problem for abstract algebras.

To preserve the security of the cipher, each symbol of this derived sequence is used only once for each encrypted message. Once all symbols are within an expanded sequence are used, and if the message encryption process is not finished, said sequence ought to be symbolically factored in its entirety again to generate a new sequence, preferably not using symbols within a distance in the sequence smaller than the expansion factor.

Generative Logic Application

Within the methods of this invention, logic systems are constructed by symbolically factoring a sequence of symbols contained in the cipher key into an expanded sequence K, then by mapping said symbols to actual logic connectives using a secret “logic alphabet”, whereas each unique symbol of the alphabet points to a given unique logic connective. The result is a sequence w₁, w₂, . . . , wₙ, with each wₙ pointing to a given logic connective L(w), which depending on the embodiments, is part of the invention's cipher key, or a logic function/connective sequence also contained within the cipher key, or interpreted using rules contained in the cipher key, according to either given expansion and implicit factors, or expansion and implicit factors contained in the key. Each symbol of this expanded, “derived sequence”, is then used only once within each execution of cipher for a given message, as outlined above.

The generative logic system sequence is then applied in sequence to each symbol of message with the already last computed symbol of sequence already transformed with logic connective sequence. This is achieved, with the application function to groups of truth values, as binary encodings of symbols according to a given secret alphabet, for a given symbol sequence indexed by i, for p1=Tᵢ₋₁, and p2ᵢ the symbol of the current symbol being encoded, and u selected by a pseudo-random number sequence, preferably the result of symbolic factoring: !^{δ}(Tᵢ₋₁(n),p2ᵢ(n), Lᵢ(w))=Tᵢ(w,n). The result of the ciphertext is the sequence {T₁, T₂, . . . , Tᵢ₌ₗ_{_{ƒ}}}, with l_{ƒ} being the length of the sequence to be transformed by generative logic.

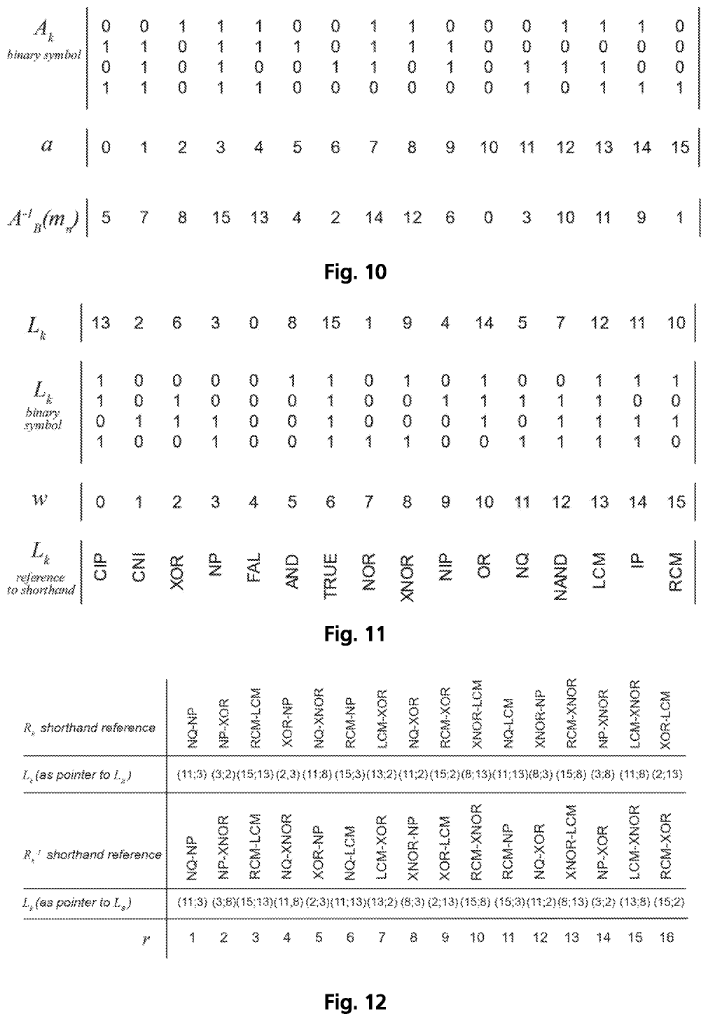

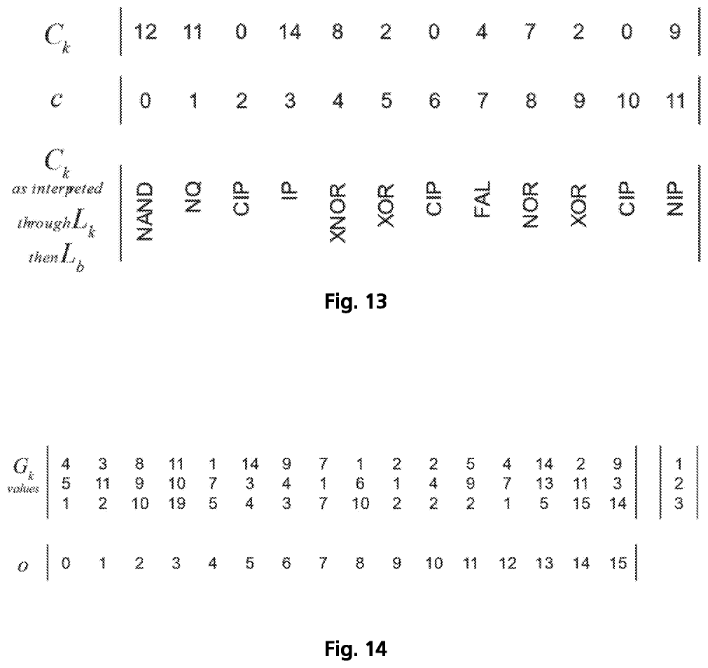

In this invention, to be able to be decoded in reverse, i.e. decrypted, an additional information is necessary and thus computed, as the symbol (i.e. predicate) resulting from the application of logic connectives loses information. As such, it is not possible to deduct from the last Tᵢ₌ₗ_{_{ƒ}} symbol alone in the sequence encoded by the generative logic the exact combination of original predicates. As such, a given “residual” truth value rᵢ, whose truth table is given in FIG. 10, for a given secret logic alphabet as given in FIGS. 6 and 10. Consequently, for a given message symbol mᵢ, and both an expanded application function r(rᵢ₋₁(n),mᵢ(n), Lᵢ(w))=(s|i(w,n); rᵢ), resulting in a symbols sequence s₁,s₂, . . . , sₙ,r₀, as exemplified in figure, as well as an inverse resolution function Rₖ⁻¹(rᵢ₋₁,sᵢ, L(wᵢ)), which for a given symbol sᵢ, function L(wᵢ), and residual rᵢ, provides the original mᵢ and rᵢ₋₁, which applied through the application function r( ), would give said rᵢ and sᵢ.

Decryption is thus achieved by applying Rₖ⁻¹( ) recursively starting with the last recorded r and s, until needed.

Non-Ordinal Symbol Transposition

Transposition with the methods of the invention is done by means of a transposition function, which deterministically selects symbols in a message and rearranges said symbols from positions poles according to a non-repeating sequence of symbols, here the expanded sequence K. Classic numbering system are built over totally ordered set which arranged number, such ordinal numbers sets (for example integers { . . . −1, 0, 1, 2, 3}, real numbers { . . . −0.4, 0.0, 3.14}), algebraic groups, rings or lattices build thereupon, etc. Number systems are, amongst other things elements, built with a so-called successor function, which with integer positive numbers for example gives the evolution from 0 to 1, 1 to 2, etc.

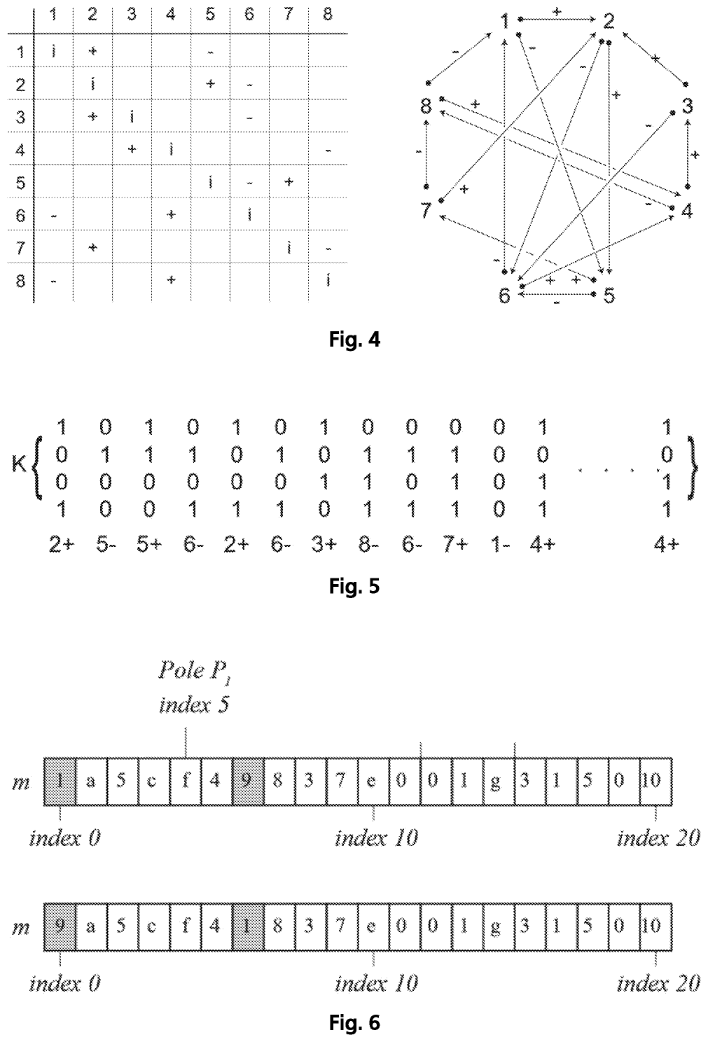

The methods of the invention generate based on cipher key and the expanded sequence K a unique totally ordered set T. The set is ordered as a topology which at a minimum specifies that there must be at least two, or more, successors elements for elements in the set, as shown in FIG. 4, showing the affinity matrix and succession graph for the successor function. The successor function is also accompanied with a counting rule indicating that from a given element, the same successor, out of the minimum of two, cannot be “counted” twice in a row, and the operation of “counting” gets a new definition.

As an example, this signifies in the example of FIG. 4, that starting from 1, and counting 5 from it, one goes first to two through the first successor of 1, which is 2, then 5, then 7, then 2 again. However, following the rule that a given successor for an element may not be used twice in a row, we choose the second successor, which in this case is 6. Then, if one wants then to count 4 starting from 6, one goes from 6 to 4, 4 to 3, 3 to 2, and this time to 5 again. So, in the totally ordered set given in the example of FIG. 4, which is in effect also a non-commutative group, counting 9 from 1 gives 5.

Counting thus needs an initial state for the successors in a given ordered set T, a starting element, and a “distance” to count over the topology of the set's ordering.

Constituting a successor function T can be done in using the binary representation of the symbols of K, with one (or more) bits representing the initial ordering state of the successors from a given elements, represented here in FIG. 4 with on bit with + for the first and − for the second. Several other bits are used depending on the number of symbols to represent the symbols being counted upon. In the example of FIG. 5 corresponding to the example of FIG. 4, one can see with 4 bits from a given example segment of a K sequence how the affinity matrix above is constituted. The totally ordered set of n elements are constituted by reading (n−1) bit symbols from K at a minimum of (n|2) times, ignoring any self-reference (i.e. a number succeeding to itself), as can be seen in the example of FIG. 5.

Symbols to be transposed are switched with symbols which are selected in traditional numeric ordinal order along the plaintext. The position is calculated by adding to the ordinal numeric index position of the preceding symbol transposed a value which is a binary value chosen by a selection function. The selection function counts over the totally ordered set “T” using the successor function. The symbol at end of the count then gives an index position within a given alphabet. The index value is the value added to the position. and choses within a secret alphabet. Within a round of transposition, any symbol of the plaintext may only be selected once.

The transposition of symbols is done relative to index positions within the plaintext which are themselves generative, herein called “attraction poles”. The position of the poles is calculated by taking a fixed number of symbols from K, at a minimum performing a multiplication of their binary value. Several poles may be chosen, each position for each pole is being computed relatively to the ordinal numeric index position of the preceding pole.

Enough poles are generated up until all symbols of the original message are transposed once. The preferable maximum number of poles in embodiments ought to be

$${P}_{max} ≅ {f}_{a} ( K , {p}_{n - 1} ) ∀ ( 1 \leq n \leq ( quot ( \frac{{l}_{m}}{96} ) \times 4 ) ) .$$

Each time a pole is needed, three new symbols of K, smaller are chosen as factors of a number to which the numeric value of the binary representation of the symbol is added, which gives the position of the fourth pole.

Given K {8, 3, 4, . . . }, starting from 8, counting 3 over T: 8 to 4, 4 to 3, 3 to 2. For a given pole pᵢ at index position 5, the symbol to be transposed is located at index 7. Given a message {1,a,5,c,f,4,9,8,3 . . . }, this signifies switching the symbol 1 at index 1 and 9 at index 7 (see FIGS. 4 and 6).

The conjunction of a non-repetitive ordinality, which is non numeric and the function of the selection posed on the same base, doubled by poles also generatively chosen using K gives a very efficient diffusion parameter.

Combination of Above-Mentioned Principles and Techniques into a Cipher

The methods of this invention thus generates logic systems to restructure the messages from sequences of symbols-as-signifiers to symbols-as-transformations, and then transform the resulting symbols sequences into another symbol sequence this time devoid of signification, by applying recursively a pseudo-random sequence of logic functions forming a contextual language thus also generated by the logic system and the underlying message being encrypted.

The latter operation however has created additional information in the form of two residual symbol at the ciphertext's extremities, in addition to the authentication tag. These are indices to regenerate both the logic system and the contextual logic language, and must be subsumed into the ciphertext, which is why shorter another set of permutation is performed.

As the permutation functions are themselves recursive and driven by the symbolically derived sequence, and because start of the recursion is hidden within the number of permutations of symbols, driven by the same, the attacker must first enumerate all possible permutations of the symbols of the ciphertext, and then only be able to attack directly the cipher. Without the key, any attacker only has an abstract representation of an arbitrary logic system, with no extraneous information allowing said attacker to decode the system.

Due to the methods of this invention such enumerations are longer than brute-force cryptanalysis. As per Gödel's incompleteness theorem, the attacker has a no system, only a tautology which cannot “explain” itself without the key, which is thus fully undecidable.

### Description of the System of the Invention

As part of the system and method of the embodiments of the invention, there is a central processing unit chip (which in embodiments can be a general purpose microprocessor, or a general purpose microcontroller, or a field programmable gate array, or any other kind of electronic, optic, or quantum electronic instruction execution unit), a random access memory electronic chip, or any equivalent direct memory access chip (such as cache memory, static random access memory, “flash” memory, and any other kind of electronic, electrostatic, magnetic, or optical direct access memory system), as well as a cipher algorithm recorded either in the random access algorithm in the form of a list of instructions in a format receivable by the central processing unit, or in a computer machine language which can be either compiled or translated to such a list of instructions which can be directly interpreted by the central processing unit.

In embodiments, such an algorithm may be any symmetric algorithm such as but not limited to block ciphers, stream ciphers, chained block ciphers, chained block ciphers with authentication tags, chained block ciphers with authentication and integrity check tags. In embodiments, the invention is then implemented as either a source code library of named or unnamed software functions, a library of named or unnamed software functions compiled into object code which can be interpreted by the central processing unit, or a software program simulating a central processing unit with a reduced instruction set but sufficient to implement the invention, or as a physical circuit embedded on an external chip directly physically connected to at least the computing system's central processing unit. The system may or may not have an external physical memory storage system.

Pre-Requisites for the Methods

The system must have recorded in random access or permanent memory of the invention's central processing unit:

A message or plaintext “m” to be encrypted, stored as a finite sequence of bits, whereas m∈{0,1}*. The length of the message ought preferably for practical purposes be larger than l(m)=lₘ≥768 bits, however, in case the authentication tag is omitted, it must be at a minimum of lₘ>128 bits.

A key “k” for the symmetric cipher, stored as a finite sequence of bits, whereas k∈{0,1}*. The length of the key sequence ought for practical purposes be larger than lₖ≥128 bits to provide for sufficient levels of entropy, in this embodiment, lₖ≥256 bits.

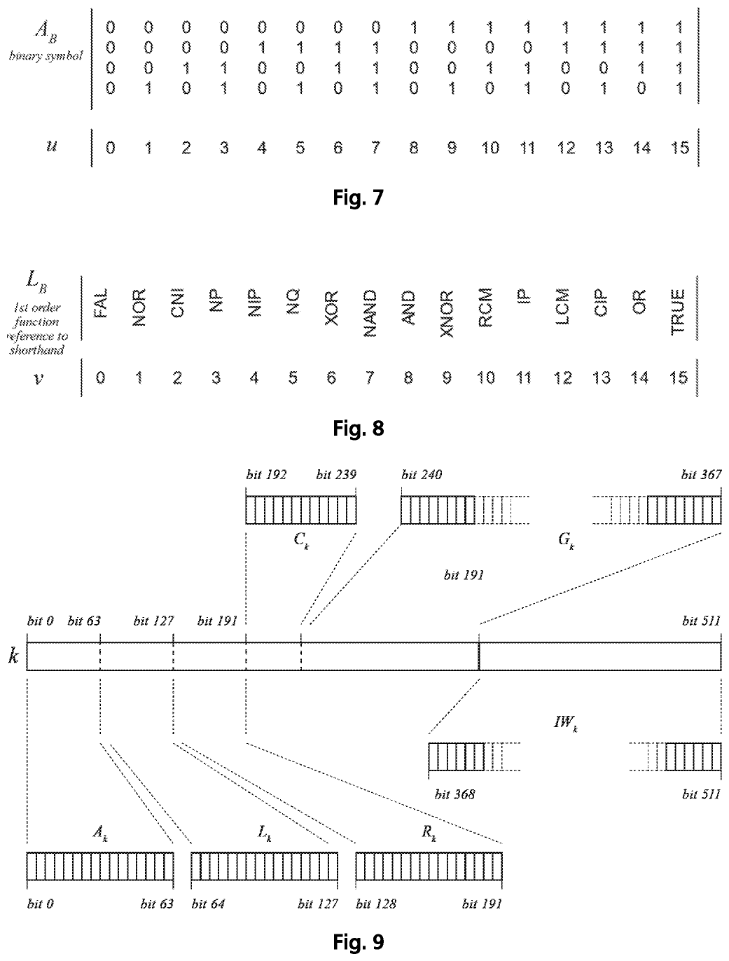

A base semiotic set “A_{B}” such as A_{B}={a_{b,1}, a_{b,2}, . . . , a_{b,2}_{^{b}}, whereas a_{b,n}∈{0,1}*, each a sequence of binary symbols of length b, indexed by u starting with 1, and ordered according the order of the numeric values of each symbol interpreted as a binary numeral. The minimal length b for each symbol ought preferably for practical purposes to be b>6, although it must be at a minimum of b≥4, as exemplified in this embodiment and in FIG. 7.

A reference logic index containing all 16 first order logic functions, expressed at a minimum as a composition of the basic logic functions AND, OR, NOT. In embodiments, such functions are represented in memory either as sequences of microcode instructions for the invention's system's processor, or as sequences and combinations of the most basic logic functions or the minimum set of logic gates (AND, OR, NOT), operating over two central processing unit registers, providing the result in a third register.

A base logic set “L_{B}” of 16 memory pointers addresses to functions of the reference logic index, ordered and indexed by “v” starting with 1, arranged in standard order of the values in binary base numerals of the representation of each such function's it's truth table. L_{B} is accompanied by a selection function L_{B}(v), returning instructions of the first order logic function located at the memory address pointed by the pointer indexed by v, as exemplified in this embodiment and in FIG. 8.

A keyed authentication function for the message m resulting in the authentication tag HMAC(m,kₐ)=h, represented as a binary sequence, or any other function using at least the m and kₐ as parameters, but in all cases represented as a sequence of microcode instructions for the invention's system's processor. For practical purposes, keyed authentication function ought to be either a standard recent function such as SHA3-256, or a symbolic conjunction of the message using the logic context of the key (see further below).

An authentication key “kₐ”, for use in a keyed authentication function (i.e. HMAC), stored as a finite sequence of bits, whereas kₐ∈{0,1}*. The length of the key sequence ought for practical purposes be larger than lₖ_{ₐ}≥256 bits to provide for sufficient levels of security against quantum attacks (corresponding to collision resistance of 128 bits of entropy).

Transformation of the Inputs and Preparation of the Generative Logic Ruleset

The key k is not in the general form of a binary sequence representing one or two random large numbers used in various algebraic calculations, as is done in traditional ciphers designs or newer quantum resistance ciphers. In the methods of this invention, the key k is in effect a composite data structure containing sequentially several different types of information.

The k binary sequence can thus be segmented into the parameters necessary for the setup of the ciphers. Each parameter is in itself a data structure, which is after segmentation stored in random access memory or permanent memory of the invention's system.

A secret semiotic set “Aₖ”. Aₖ is encoded as a binary sequence of length b×2^{b}=Aₖ, and itself segmented in 2^{b} binary symbols, each representing a unique binary value between 1 and 2^{b} randomly arranged. For b=4, the length of l(Aₖ)=64, in which case bits no 1 to no 64 are copied to the system's random-access memory or in its permanent memory as the set Aₖ. In all cases, Aₖ is itself indexed by “d”. Each value of Aₖ corresponds to an index u of A_{B}. Aₖ is accompanied by a selection function Aₖ(a)=u, as well as an inverse resolution function Aₖ⁻¹(s)=a, which for a given symbol s∈A_{B} returns said symbol's index a within Aₖ, so that A_{B}(u)=A_{B}⁻¹(s).

A secret logic set “Lₖ” Lₖ is encoded as a binary sequence of a length of 64 bits, and itself segmented as 16 elements of 4 bits long, each element representing unique value between 1 and 16, in an order randomly arranged within Lₖ.

Lₖ is itself indexed by w, each corresponding to a unique element index v of. Lₖ is accompanied by a selection function Lₖ(w)=v, as well as an inverse resolution function Lₖ⁻¹(ƒ)=w, which for a given function within L_{B} returns the index value within Lₖ for said function.

A set of secret residual indexes “Rₖ” Rₖ encoded as a binary sequence of a length of 128 bits, and itself segmented as 16 elements of 4 bits long. The elements of R are indices of functions in Lₖ used to compute “residual” truth values for corresponding “k” index in Lₖ.

Each symbol in Rₖ thus refers to a bijective function pair for any given truth value and associated residual truth value for the first order logic functions of L_{B}, in addition to the truth values computed by each function, thus allowing us to define an inverse isomorphic function over k for each one, making decryption possible for any symbol sequence encrypted with generative logic.

Rₖ is itself indexed by r, each corresponding to a value indexed by w. by an accompanying selection function such as Lₖ(l)⊃Rₖ(r)∀r=l, as well as an inverse resolution function Rₖ⁻¹(r,s, ƒ)=(p₁,p₂), which in mathematical terms, given a first order logic function, a resulting truth value and a residual truth value, deduces the two original predicate logic proposals used to compute said resulting truth value and residual truth value for a given function Lₖ(l) returns the index value within Lₖ for said function.

The logic connectors NQ, XOR, XNOR, RCM residual truth value encodings corresponding to the traditional t truth values may be randomly selected from the set {1100,0011}. The logic connectors NIP, NAND, AND, IP residual truth value encodings corresponding to the traditional t truth values first two may be randomly selected from the set {00,01,10,11}, while the next two pay be selected randomly from the set {01,10}. The logic connectors NOR, CNI, CIP, OR residual truth value encodings corresponding to the traditional t truth values first two may be randomly selected from the set {01,10}, while the next two pay be selected randomly from the set {00,01,10,11}. The logic connectors FAL, NP, LCM, TRU residual truth value encodings corresponding to the traditional t truth values may be randomly selected from the set {1010,1001,0110,0101}. FIG. 12 shows an example of such an Rₖ set with the correspondences within Lₖ. These residual values sets for each first order logic function can alternatively be expressed as the result of a first order logic functions from L_{B} whose truth table is equivalent.

A secret logic context “Cₖ”. Cₖ is encoded as a binary sequence for which l(Cₖ)≥48 bits for b>4, and larger for larger values of b. The generative context contains a list of selectors for logic function selectors within Lₖ used for to generate logic models, as well as perform symbolic factoring and logic synthesis.

Cₖ is indexed by c, and is accompanied by a selection function Cₖ(c)=w, each element thus selection a logic function pointer within Lₖ. Each element in Cₖ is a sequence of random non-unique values between 1 and 16, coded over 4 bits; Cₖ ought preferably to have more than twelve elements, whereas the minimum is three within for the methods of this invention.

A semantic generation root “Gₖ”. Gₖ is encoded as a binary sequence of a length of minimum 2^{b} elements, which, depending on the current context within a symbolic sequence, to select the semantic composition rule over Cₖ, which within the embodiments of the invention is done using index c as a cursor over Cₖ, and providing each implicit inference between two symbols (see ƒₗ further below). In its simplest form, Gₖ is a matrix, which, as applied as applied in FIG. 19, has each column o corresponding to a given symbol within Lₖ, while each successive row p provides an advancement over c within Cₖ.

Gₖ, as a matrix, has 2^{b} columns and ƒᵢ rows, and is indexed respectively by o and p. Gₖ is also accompanied by a selection function Gₖ(o,p)=c→Cₖ(cₙ₋₁+Gₖ(o, p))=cₙ, thus providing an offset to apply to a given context for the selection of the next inference/logic function to apply or infer, for example, in performing a symbolic factoring. The column o is selected, for a context defined by a preceding symbol s in a sequence of symbols by Aₖ⁻¹(s)=o.

A symbolic selection factor “ƒₑ”. ƒₑ gives the number of symbolic factors which have to be conjugated to produce a given symbolic composition, for example if to produce two symbols given two by two, in sequence. It is used for example as a parameter for symbolic factoring. Other interpretations and usages are possible, depending on the composition rules, implicit or explicit, for example to produce triplets of symbols.

The minimum value for ƒₑ is of two bits for ƒₑ≥3, while for the practical purposes of this invention it ought to have a value 3≥ƒₑ≥16 coded over 4 bits.

A symbolic implicit inference factor “ƒᵢ”. ƒᵢ gives the number of signifiers or symbols which can be implicitly and recursively inferred, between two or more symbol depending on the interpretation rules (see ƒₑ), in using the language generated by the semantic context and generation roots within a coherent sequence of symbols generated by a conjugation of said symbols logic functions within said language and generating context.

The minimum value for ƒₑ is of 1 bit, while for the practical purposes of this invention it ought to have a value of ƒₑ>6, so that 1≥ƒᵢ≥16 coded over 4 bits.

An initialisation word “IWₖ”. IWₖ is an initialisation as a random sequence of bits, segmented as a sequence of symbols (thus an initialisation word, not a numeric initialisation vector) IWₖ has a minimal length of 76 bits of length, for the practical purposes of this invention a preferable length for sufficient entropy is 132 bits (see diagram 14).

Setup for the Generative Logic Synthesis Cipher

Segment m in short bit sequences of length b; then map each one to its symbol index in A_{B} using the function B(m; A_{B})=m_{B}, applying A_{B}_{^{−1}} to each segmented bit sequence. m_{B} is indexed by n_{b} and is accompanied by a selection function m_{B}[n_{b}]; then,

Derive a pseudo-random symbol sequence “K”. K is derived from I_{B} by symbolic factoring. As the latter might not provide a sufficiently long stream sequence to encrypt longer m messages, as such, a pseudo-random sequence of required length is, shall, for the methods of this invention, be derived from I_{B}.

Within the methods of this invention, derivation is performed by symbolic factoring of pairs of symbols within I_{B}, whereas the conjunction logic corresponds to searching by inference a symbol sequence which, conjugated by applying logic functions a according to a given secret logic context and semantic root, result in the symbol sequence I_{B}. In other words, which sequence of symbols and logic actions results in the two given symbols. Each symbol pair is thus the result of a coherent conjugation, within the linguistic context and logic sequence defined by Lₖ, and ƒᵢ, of a given set of ƒₛ symbols. Implicit sequences of ƒₗ symbols and logic actions are also calculated between two encoded symbols (i.e. implicit predicates, as the basic elements of the language are first order logic functions).

!ₖ^{σ}(I_{B} [nₖ]; I_{B}[nₖ+1])=K is an algorithm which is applied in nₖ ∀[(l(m_{B})/ƒₛ)+nᵢ]≥nₖ≥l_{ƒ} iterations, starting with symbol sequence I_{B}, and then recursively to all resulting intermediary sequences until the requisite sequence length is achieved. The algorithm recursively searches, starting from the second symbol I_{B}[nₖ+1], the preceding symbol in the sequence, using a logic function selected depending on said symbol by an inverse resolution to the function a( ) as defined right above, similar in principle to Rₖ⁻¹( ), defined earlier.

The a_{L,2}⁻¹(Lₖ⁻¹[Kₙ₊₁], I_{B}[nₖ],I_{B}[nₖ+1]) function deduces from each successive bit of the two given symbols, and from the truth table of selected function pointed over Lₖ on L_{B} the successive bits of p2. The function is applied recursively. This latter function is applied recursively in ƒᵢ×(ƒₑ+1) iterations (i.e. colloquially, “applied x times over the result over the result of the preceding application) with only each “ƒᵢ”^{-th} symbol encoded in the factor sequence, the rest being implicit.

The K sequence is indexed by nₖ with a selection function K[nₖ]; then,

Conjugate an “mᵢₙᵢₜ” initialization symbol sequence such as mᵢₙᵢₜ=(m_{k,1}, m_{k,2}, . . . , m_{k,n}_{ᵢ})∀[(m_{k,n}∈A_{B})∧(1≥nᵢ≥l(mᵢₙᵢₜ))], with preferably l(mᵢₙᵢₜ)<2^{b} by applying the application function init(Lₖ[Cₖ[nᵢ]], I_{B} [2×c], I_{B} [(2×c)+1]) using logic operators from L_{B} selected by L_{B} (L|k(C|k(nᵢ))) to successive pairs of elements of IWₖ segmented in symbols of length b as I_{B}, which will result in a sequence with half the number of elements. Record the resulting sequence as mᵢₙᵢₜ, continue recursively applying init( ) preferably in embodiments, only 16 symbols and record the sequence as mᵢₙᵢₜ. Continue then applying init( ) to the intermediary symbol sequences until only two symbols m_{i,1} and m_{i,2} remain, which are also t be recorded;

Compute a generative logic function sequence “ED_{K}”. The sequence of logic actions to be applied to the ciphertext is constituted by mapping each element of nₖ, interpreted as a pointer to the corresponding index represented by said symbol of K as its numeric value w indexing Lₖ, and then associated the truth values within the corresponding residual index within Rₖ with K[nₑ]=w=r. Each element of ED_{K} thus takes the form of a pair (ƒ_{L}∈ [symbol] _{B}; ƒ_{R}∈ [symbol] _{B}) with each ƒ_{L} and ƒ_{R} pointing to a given function within L_{B} through Lₖ.

The resulting suite ED_{K}, indexed with nₑ, and a selection function E(nₑ) is thus computed with the so that the resulting suite ED_{K}=Σₙ_{ₑ}₌₁ⁿ^{ₑ}^{=l}^{_{ƒ}}(Lₖ⁻¹(K[nₑ]); Rₖ(Lₖ⁻¹(K[nₑ]); Rₖ(Lₖ⁻¹(K[nₑ])));

Encryption by Generative Logic

Transform m_{B} into a restructuration sequence “M_{ƒ}” m_{B} is not used directly in the encryption, rather, what is being encrypted is a sequence which allows, given a secret alphabet Aₖ, and a computed expanded sequence K, to reconstruct m_{B}.

Mathematically, we do not encrypt direct signifiers, but rather a sequence of morphisms as a sequence of relative functional and operative references. The structuration is recursive, each new coded symbol pointing to a functional operand which depends on the preceding operands as well as to the current element of m_{B} whose reconstruction needs to be encoded.

The structuration can either be done in relation to a fixed artificial language, for example the set of first order logic functions, if there is a sufficient number of coding bits b>5. The evolution can also be encoded with regard to a simpler evolution over a set of binary symbols, as exemplified in the embodiment described hereunder using the algorithm T_{A}(m_{B}, Aₖ, K) to construct the symbol sequence M_{ƒ}, here as signifiers are encoded as being part of a context Lₖ, M_{ƒ} being indexed by nₘ, and accompanied by a selection function M_{ƒ}[nₘ];

Whereas a function T(Aₖ; a₁; a₂) returns the edit distance within a given Lₖ of between two symbols a₁ and a₂, the particular form of that function used in embodiments is T(Aₖ,m_{B}+mᵢₙᵢₜ[n−1], m_{B}+mᵢₙᵢₜ[n], K[n]). As a consequence, mᵢₙᵢₜ and m_{B} are concatenated before as M_{B}[n_{b}]. The resulting recursive sequence Σₙ_{_{ƒ}}₌₁ⁿ^{_{ƒ}}^{=l}^{_{ƒ}}T(Aₖ, Aₖ, M_{B}[n_{ƒ} ]) is computed with l_{ƒ}=l(mᵢₙᵢₜ)+l(m_{B}); only the last l(m_{B}) elements in the sequence are recorded in M_{ƒ}. M_{ƒ} is indexed by n_{ƒ}, and accompanied by a selection function M_{ƒ}[n_{ƒ}]; then,

A more involved version providing for higher levels of undecidability while maintaining good encryption performance can be encoded with a list of first order logic functions within Lₖ to be recursively applied to pairs of symbols from m_{B}[nₖ−2] and M_{ƒ} to get m_{B}[nₖ], also starting with the symbol mᵢ.

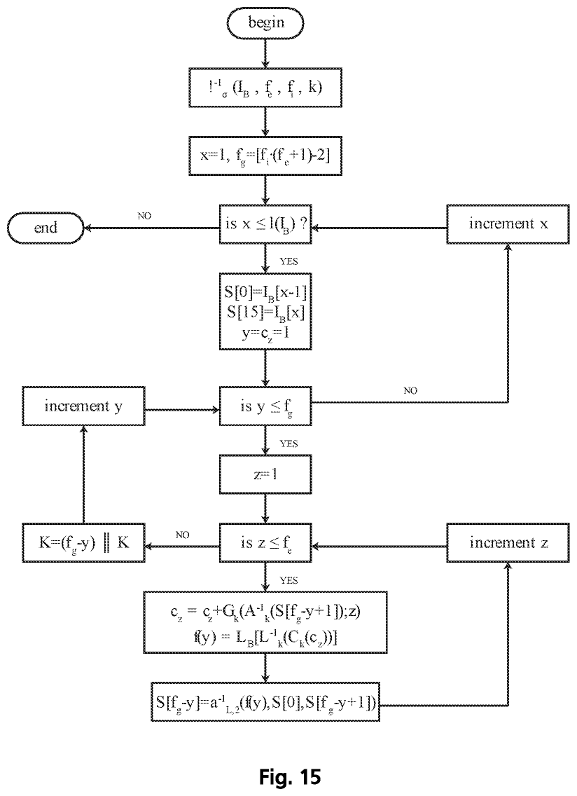

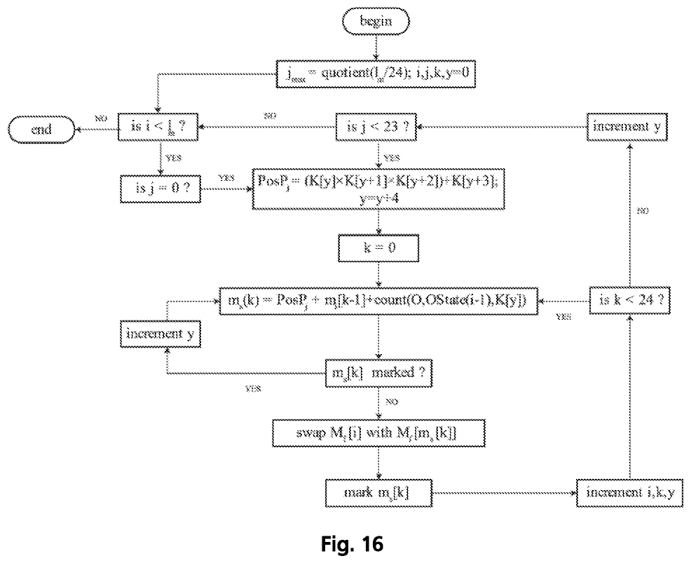

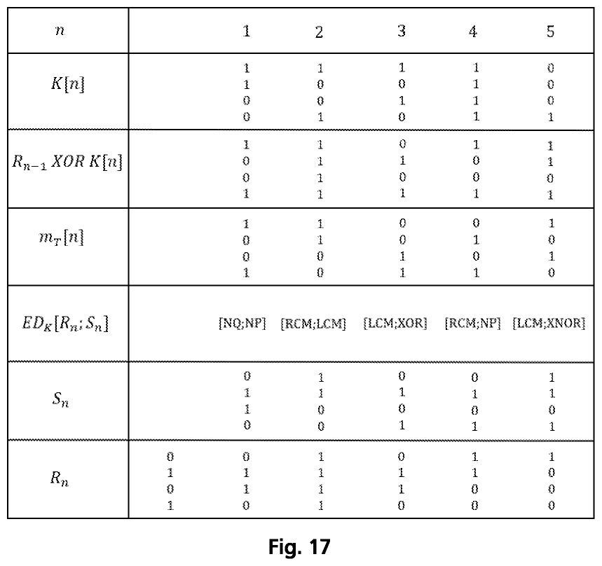

Transpose the elements of M_{ƒ} into a sequence “M_{T}” The transposition is done using a symbol selection function mapped over M_{ƒ} by a totally ordered set T, generated from k, and contextually evolving over K. The algorithm is shown in FIG. 15.

The symbols positional index in M_{ƒ} are sequentially permuted (i.e. the symbols are “swapped” with each other starting with a set of attractor poles “Pⱼ” whose relative position over M_{ƒ} is generated by K, using the attractor function P(p(M_{ƒ}[n_{ƒ} −1]), M_{ƒ}[n_{ƒ}], K[n_{ƒ}]). M_{T} is indexed by nₜ and accompanied by a selection function Mₜ[nₜ].

Infer a symbol sequence M_{g} using the generated logic sequence ED. The message itself is not encrypted, rather what is being encrypted is the restructuration sequence, which applies the logic function sequence ED_{K} recursively to M_{T}. The resulting symbol sequence M_{g} however only retaining the symbol encodings starting with the symbols of M_{T}, as what precedes is implicitly encoded from mᵢₙᵢₜ.

Sₑ, indexed by nₛ and accompanied by a selection function S[nₛ], is computed using an application function r(K, Mₜ, E, nₜ) such as r ((rₙ_{ₜ}₋₁ XOR K[n]), Mₜ, ED[nₜ])=(sₙ; rₙ). r(K, Mₜ, E,nₜ), selects a first order logic function within ED_{K}, the residual value of the preceding symbol ED_{K} being encoded, as well as the current symbol within M_{T}[nₛ], and returns as a result an encoding symbol sₙ_{ₛ}, and a residual value rₙ_{ₛ} to be used to compute s(nₛ+1).

The resulting sequence M_{g}=r(K, Mₜ, E, nₜ), indexed by nₛ and accompanied by a selection function S[nₛ], is thus computed recursively by M_{g}=Σₙ_{ₜ}₌₁ⁿ^{ₜ}^{=l}^{_{ƒ}}[R(K, Mₜ, E, nₜ)∨R(k, Mₜ, E, Nₜ₋₁)], discarding all rₙ_{ₜ} symbols but recording the last rₗ_{_{ƒ}} in memory. Symbols of M_{g} and rₙ may be substituted by equivalents in Aₖ;

FIG. 17 shows an example of the recursive transformation from the logic function message M_{T}[n] (third row of FIG. 17) to the transformed logic function message M_{g}[n] (fifth row here indicated as S[n]), where n indicates the symbols of the corresponding messages and the respective recursion steps (columns of FIG. 17). The first row shows the pseudo-random symbol K of the respective recursion step. The third row shows first order logic function of the logic function sequence of the current recursion step. The fifth row shows a residual symbol of the respective recursion step. The second row shows the XOR combination of the residual symbol of the preceding recursion step and the pseudo-random symbol of the respective recursion step. The symbol of the transformed logic function message of the current recursion step (e.g. n=2) is obtained by applying the first order logic function of the current recursion step (NAND) to the two input symbols of the current recursion step (second and third row of column n=2) and reading out the truth values. The first order logic function NAND is applied bitwise to the two symbols. The first bit of the first input symbol (0011) is 0 and the first bit of the second input symbol (1100) is 1 for the current recursion step. Using now the first order logic function NAND as shown in FIG. 12 results that the combination of 0 as first proposition and 1 as second proposition is given in the 3rd line of NAND, so that the 3rd line of the truth value tn gives the resulting first bit value 1 of the transformed logic function message symbol of the current recursion step. Analogously, the 3rd line of the residual truth value Rk gives the resulting first bit value 1 of the residual symbol of the current recursion step. Since the second bit of the first and second input symbol are equal to the first bit, the second bit of the transformed logic function message symbol of the current recursion step is also 1 and the second bit of the residual symbol of the current recursion step is also 1. The third bit of the first input symbol (0011) is 1 and the third bit of the second input symbol (1100) is 0 for the current recursion step. Using now the first order logic function NAND as shown in FIG. 12 results that the combination of 1 as first proposition and 0 as second proposition is given in the 2nd line of NAND, so that the 2nd line of the truth value tn gives the resulting third bit value 1 of the transformed logic function message symbol of the current recursion step. Analogously, the 2nd line of the residual truth value Rk gives the resulting third bit value 0 of the residual symbol of the current recursion step. Since the fourth bit of the first and second input symbol are equal to the third bit, the fourth bit of the transformed logic function message symbol of the current recursion step is also 1 and the second bit of the residual symbol of the current recursion step is also 0. So, the first output symbol yields 1111 (transformed logic function message symbol of the current recursion step) and the second output symbol (1100) (residual symbol of the current recursion step). The second output symbol (1100) is combined via XOR with the pseudo-random symbol K (1010) of the next recursion step (n=3) resulting in the first input symbol of the next recursion step (1011). Then, the described recursion process is repeated. This example transforms the logic function message symbol-wise. It is however also possible to do this bit-wise.

Compute the authentication tag h for m_{B} using the given function h(m_{B}, I_{B}) or any other given value of kₐ instead of I_{B}, or any given function keyed message authentication function which can be substituted in its stead, using the given recorded instruction sequence and parameters required by such a function, as long as said sequence resulting tag length is greater than 40 bits and shorter than 120 bits for b>4; then,

Transpose the concatenation of the h authentication tag and rₙ into M_{g}, using the same transposition as for M_{T} above, except in this case transposing bits of the concatenation (h∨rₙ) within M_{g}, thus forming the final ciphertext sequence c, which can be then recorded as bytes ready for storage or transmission.

Decryption by Generative Logic Synthesis

Perform all the steps above up to 4.4; then verify the authentication tag h with kₐ, M_{g} and mᵢₙᵢₜ, by reconstituting the transposition sequence using the corresponding segment of K used to transpose from h and rₙ to c originally, then by permutating bits in inverse order to recover these two concatenated sequences along with M_{g}, then verify h; if it succeeds, segment M_{g} in symbols of length b; if it fails, stop decrypting; otherwise,

Deduct Mₜ from M_{G} using the generated logic sequence ED by recovering each intermediary (rₙ_{_{g}}₋₁ xor Kₙ_{_{g}}) symbol from the former sequence by recursively applying the Rₖ⁻¹ (rₘ_{_{g}}, n_{g}, E[n_{g}]) (Mₜ[l_{ƒ} −n_{g}]; (rₙ_{_{g}}₋₁ xor K[_{g}])) inverse bijective resolution function pair to each (r, s) pair of M_{g}, starting from the rₙ and the first symbol s of M_{G} to the last symbol sₙ of M_{G}, for 1≤nₜ≤l(M_{G}). then, recover the next r for the next s symbol by applying the inverse resolution function s_{L,1}⁻¹(K[n_{g}], (rₙ_{_{g}}₋₁ xor K[n_{g}]), XOR).

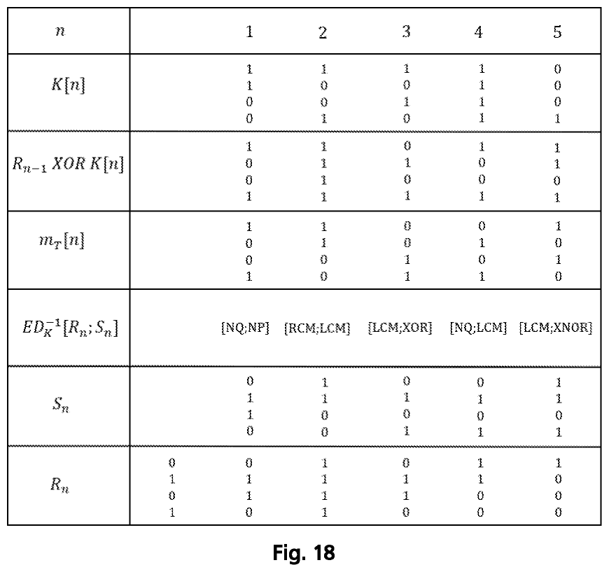

FIG. 18 shows the example of the recursive transformation from FIG. 17 but for decryption. For decryption, the transformed logic function message symbols S (fifth row) and the last residual symbol (sixth-row and last column) are received as inputs. The recursive process starts now from the end (e.g. n=5). Now, the first order function (in the fourth direction) of the current recursion step (here XNOR) is used. The transformed logic function message symbol of the current recursion step (1011) is used as first input representing the truth values and the residual symbol of the current recursion step (1101) is used as the second input representing the residual truth value (0010). The first order logic function XNOR is applied bitwise to the two input symbols. The first bit of the first input symbol (1101) is 1 and the first bit of the second input symbol (0010) is 1 for the current recursion step. Using now the first order logic function XNOR as shown in FIG. 12 results that the combination of 0 as truth value and 1 as residual truth value is given in the 3rd line of XNOR, so that the 3rd line of the first proposition p1 gives the resulting first bit value 0 of the first output symbol of the current recursion step. Analogously, the 3rd line of the second proposition gives the resulting first bit value 1 of the second output symbol of the current recursion step. The same procedure is applied to the other bits of the two input symbols to obtain the remaining bits of the two output symbols. The second output symbol of the current recursion step corresponds to the logic function message symbol of the current recursion step. The first output symbol is combined with the pseudo-random symbol of the current recursion step via an inverse XOR to obtain the second input symbol of the next recursion step (n=4). Then, the described recursion process is repeated. This example transforms the logic function message symbol-wise. It is however also possible to do this bit-wise.

Transpose M_{G} back to M_{ƒ} back by reconstituting the transposition sequence using the corresponding segment of K used to transpose to M_{G} originally, then perform the permutations in inverse order to recover M_{ƒ}; then

Reconstruct m_{B} from the restructuration sequence “M_{ƒ}” according to a context Aₖ, by generating using K the sequence of symbols M_{d}=Σₙ_{_{d}}₌₁ⁿ^{_{d}}^{=l(S|d)}Aₖ(Aₖ⁻¹(K[n_{d}])+n_{d-1}), with accompanying selection function M_{d}[n_{d}]; then reconstituting m_{B} starting with from the last symbol in M_{ƒ}, recovering m_{B} with T⁻¹(Aₖ; M_{d}[n_{d}]−M_{ƒ}[n_{d}−1]; M_{ƒ}[n_{d}]) m_{B}[n_{d}]; then combine symbols of m_{B} in pairs to recover the message m.

The described example was for a symmetric cipher, i.e. the same symmetric key is used for encryption and decryption. However, also an asymmetric cipher can be created with the present invention.

1. Method decrypting and/or encrypting an input message:
providing five, six, or more of sixteen first order logic functions;
decrypting and/or encrypting the input message based on the at least six first order logic functions.

2. Method according to claim 1, wherein at least two of said first order function are chosen from LCM, RCM, XOR, XNOR, NQ, NR.

3. Method according to claim 1, wherein a residual truth value is associated to each of the at least six first order logic functions, or as equivalents to one of the first order logic functions so as to form a bijective function combination pair.

4. Method according to claim 1, wherein a generative logic ruleset is defined, wherein the generative logic ruleset comprises a logic set (Lk) comprising the at least five first order functions and a semiotic set (Ak) comprising a number of symbols in a certain order, wherein the decryption and/or encryption of the input message (m) is based on generative logic ruleset.

5. Method according to claim 4, wherein the generative logic ruleset, the logic set (Lk) and/or the semiotic set (Ak) depends on the cipher key (k).

6. Method according to claim 1, wherein a pseudo-random symbol sequence (K) is determined based on the cipher key (k).

7. Method according to claim 6, wherein an initialisation word (IWk) is derived from the cipher key (k) and the pseudo-random symbol sequence (K) is derived from the initialisation word (IWk) by an expansion function which increases the length of the pseudo-random symbol sequence (K) compared to the initialisation word (IWk),
wherein symbolic factoring is used as an expansion function, wherein symbolic factoring uses the logic set (Lk) and the semiotic set (Ak) to derive the pseudorandom symbol sequence (K) from the initialisation word (IWk),
wherein an input symbol sequence is based on the initialisation word (IWk), wherein symbolic factoring combines a first input symbol and a second input symbol of the input symbol sequence by a first order logic function selected for the combination of the two symbols to derive at least one output symbol, wherein an output symbol sequence is based on the at least one output symbol, wherein the pseudo-random symbol sequence (K) is based on the output symbol sequence.

8. Method according to claim 1, wherein decrypting and/or encrypting the input message comprises at least one processing step including processing an intermediate input message to obtain an intermediate output message, wherein the intermediate input message is based on the input message, wherein an output message of the decryption or encryption is based on the intermediate output message.

9. Method according to claim 8, wherein the at least one processing step comprises a structuring step, wherein
either the structuring step comprises for encrypting the input message the following steps:
provide an initialisation symbol sequence (minit);
combine, preferably concatenate the initialisation symbol sequence (minit) with an intermediate input message of the structuring step to obtain a combined symbol sequence;
transform the symbols of the combined symbol sequence based on the semiotic set (Ak) and/or the logic context and based on the pseudo-random symbol sequence (K) into a transformed symbol sequence, wherein an intermediate output message of the structuring step depends on the transformed symbol sequence or the structuring step comprises for decrypting the input message the following steps:
provide an initialisation symbol sequence (minit);
determine a part of a retransformed symbol sequence based on the initialisation symbol sequence;
retransform the symbols of the intermediate input message into the retransformed symbol sequence based on the semiotic set (Ak) and/or the logic context and based on the pseudo-random symbol sequence (K), wherein an
intermediate output message of the structuring step depends on the retransformed symbol sequence.

10. Method according to claim 8, wherein the at least one processing step comprises a transposition step, wherein
either the transposition step comprises for encrypting the input message the step of transposing symbols or bits of an intermediate input message of the transposition step based on the pseudo-random symbol sequence (K) to obtain a transposed sequence, wherein an intermediate output message of the transposition step depends on the transposed sequence;
or the transposition step comprises for decrypting the input message the step of re-transposing symbols or bits of an intermediate input message of the transposition step based on the pseudo-random symbol sequence (K) to obtain an intermediate output message of the transposition step.

11. Method according to claim 10, wherein a succession function for counting is defined with at least two different successors for an element and with a successor rule for deciding under which condition which successor is applied, wherein the symbols or bits are transposed or re-transposed based on the succession function.

12. Method according to claim 8, wherein the at least one processing step comprises a logic function step, wherein
either the logic function step comprises for encrypting the input message the following steps:
providing a logic function series (EDk);
transforming a logic function message based on the logic function series (EDk) into a transformed logic function message, wherein an intermediate output message of the logic function step for encryption depends on the transformed logic function message, wherein the logic function message depends on an intermediate input message of the logic function step for encryption;
or the logic function step comprises for decrypting the input message the following steps:
providing a logic function series (EDk);
re-transforming a transformed logic function message based on the logic function series (EDk) into a logic function message, wherein an intermediate output message of the logic function step for decryption depends on the logic function message, wherein the transformed logic function message depends on an intermediate input message of the logic function step for decryption.

13. Method according to claim 8, wherein the at least one processing step comprises either
for encryption the following steps:
the structuring step, wherein an intermediate input message of the structuring step depends on the input message;
the first transposition step, wherein an intermediate input message of the first transposition step depends on the intermediate output message of the structuring step;
the logic function step, wherein an intermediate input message of the logic function step depends on the intermediate output message of the first transposition step;
the second transposition step, wherein an intermediate input message of the second transposition step depends on the intermediate output message of the logic function step and on a hash resulting from one of the previous intermediate input messages or one of the previous intermediate output messages and/or on an further decryption initialization value output from the logic function step;
for decryption the following steps:
the second transposition step, wherein an intermediate input message of the second transposition step depends on the input message, wherein an intermediate output message of the second transposition step and a decryption initialisation value and/or a hash is given out from the second transposition step;
the logic function step, wherein an intermediate input message of the logic function step depends on the intermediate output message of the second transposition step and the decryption initialisation value;
the first transposition step, wherein an intermediate input message of the first transposition step depends on the intermediate output message of the logic function step;
the structuring step, wherein an intermediate input message of the structuring step depends on the intermediate output message of the first
transposition step, wherein the output message depends on the intermediate output message of the structuring step.

14. Apparatus configured to perform the steps of the method of claim 1.

15. Computer program configured to perform the steps of the method of claim 1 when executed on a processor.
